(19) United States
(12) Patent Application Publication
(10) Pub. No.: US 2024/0188490 A1
(43) Pub. Date: Jun. 13, 2024

(54) Force Amplified Fastener for Power Tool Implements

(71) Applicant: TECHTRONIC CORDLESS GP, Anderson, SC (US)

(72) Inventors: Koon For CHUNG, Kwai Chung (CN); Tsz Kin WONG, Kwai Chung (CN)

(21) Appl. No.: 18/287,761

(22) PCT Filed: Apr. 22, 2022
(86) PCT No.: PCT/CN2022/088439

§ 371 Date: Oct. 20, 2023

Related U.S. Application Data
(63) Continuation of application No. PCT/CN2021/089276, filed on Apr. 23, 2021.

(30) Foreign Application Priority Data
Apr. 23, 2021 (WO) PCT/CN2021/089276

(51) Int. Cl. A01D 34/73; A01D 34/416

(52) U.S. Cl. CPC A01D 34/733; A01D 34/416

(57) ABSTRACT

Systems and methods which provide force amplified fastener assemblies configured for use with respect to detachable implements for power tools are described. Force amplified fastener assemblies may implement various gear train configurations for giving a mechanical advantage with respect to manual manipulation of the fastener assembly. A force amplified fastener assembly may include a lock mechanism operative to lock and/or unlock the force amplified fastener assembly and thus a fastening element thereof. In some examples, a force amplified fastener assembly may include a grasping member assembly for facilitating manual application of torque. Additionally or alternatively, a force amplified fastener assembly may include a removable and replaceable external surface covering configured to protect at least a portion of the force amplified fastener assembly. Force amplified fastener assemblies of embodiments of the invention may be utilized in place of a conventional lock nut for affixing detachable implements to power tools.

### CROSS-REFERENCE TO RELATED APPLICATIONS

The present application is a continuation-in-part of Application No. PCT/CN2021/089276 filed Apr. 23, 2021 and entitled “FORCE AMPLIFIED FASTENER FOR POWER TOOL IMPLEMENTS,” the disclosure of which is hereby incorporated herein by reference in its entirety.

### TECHNICAL FIELD

The present invention relates generally to garden machines having detachable implements and, more particularly, to fasteners useful with respect to detachable implements for power tools.

### BACKGROUND OF THE INVENTION

Various configurations of power tools are commonly used in performing routine tasks in daily life. For example, power tools in the form of garden machines, such as lawn mowers, brush cutters, string trimmers, grass edgers, etc., are used every day by persons performing work and leisure related tasks. These power tools often comprise a motor of some form (e.g., electric motor or internal combustion motor) outputting power via a shaft which drives an implement configured for the related task. As examples, a lawn mower may drive an implement in the form of a grass cutting blade, a brush cutter may drive an implement in the form of a multipurpose cutting blade, a string trimmer may drive an implement in the form of string spool head, and a grass edger may drive an implement in the form of an edging blade.

An implement may be configured to be detachable from a host power tool. For example, detachable implements may be utilized to accommodate selection of an implement configuration for a particular task (e.g., selectively installing a grass cutting blade configured for mulching or clipping collection, etc.) and/or to facilitate replacing or repairing a damaged implement (e.g., removal and reinstalling a grass cutting blade after sharpening its previously dulled edges or replacing a dull grass cutting blade with a sharp grass cutting blade, etc.).

Typically, one or more tools are required for changing (e.g., removing and/or installing) a detachable implement. For example, a hand tool in the form of a wrench (e.g., open-end wrench, socket wrench, or adjustable wrench) in the appropriate size for engaging a fastener (e.g., locking nut assembly, such as a reusable nut and lock washer, single use nyloc nut, etc.) affixing the implement to a shaft assembly (e.g., spindle) of the power tool is needed for changing a detachable implement. Additionally, a hand tool in the form of a brace or second wrench is often needed to prevent movement of the shaft and implement when tightening or loosening the fastener affixing the implement to a shaft assembly of the power tool for changing the detachable implement. As an alternative to a second hand tool, some implementations have used a pin which may be manually pushed inside an aligned hole in order to lock the spindle of the power tool. As another alternative to a second hand tool, such as may be implemented with respect to a power tool that does not provide for reverse rotation operation, a shaft bearing of the power tool may be replaced by a one-way bearing that serves as spindle lock.

In many situations, the fastener affixing the implement to the power tool is seated with appreciable torque (e.g., intentionally, such as to prevent unwanted relative displacement of the implement due to driving forces and/or impacts during use, or unintentionally, such as resulting from inertial tightening in association with application of driving forces). Accordingly, a wrench used for changing a detachable implement must be of sufficient length and durability to accommodate facilitate application of significant forces on a nut fastening the implement on the garden machine, such as when unfastening the implement.

It is often difficult or impractical to store hand tools appropriate for changing a detachable implement on or with the power tool. For example, even where the size and bulk of such hand tools may be provided some form of storage space on a power tool, the often rugged use, presence of appreciable vibrations, etc. can cause the hand tools to migrate from their storage space and be lost. Further, power tools having detachable implements are often operated in areas away from repair facilities or places in which it is convenient or customary to store tools appropriate to changing detachable implements. For example, a lawn mower, string trimmer, or grass edger may be operated in a home environment in which the owner has a very limited selection of tools, and thus appropriately sized hand tools for changing a detachable implement may not be available to the operator. In another example, a lawn mower or brush cutter may be operated in a field or other large parcel of land relatively far from a supply of tools and, although a replacement cutting blade may be carried by the operator, sufficient tools for changing the cutting blade may not be available.

Manipulation of a fastener by hand (e.g., without aid of separate tools) to remove and replace a detachable implement is often not possible due to the forces required. For example, as described above, the fastener may have been seated with appreciable torque whereby a typical user may not be able to apply sufficient counter torque (e.g., on the order of 12 Nm) to facilitate loosening the fastener. Similarly, a typical user may be unable to apply sufficient torque to a fastener by hand to seat the fastener sufficiently to prevent unwanted relative displacement of the implement during use due to driving forces.

Various special configurations of detachable implements have been proposed to prevent unwanted relative displacement of the implement during use even in situations where a fastener is applied by hand without significant torque. For example, the blade carrier of EP 2 798 937 B1 (the disclosure of which is incorporated herein by reference) includes two pins which protrude into corresponding openings in the blade for providing a rotationally fixed connection with the blade. Such specially configured detachable implements generally do not provide a backward compatible solution. Moreover, the lack of sufficient torque when the fastening device is applied by hand to attach the specially configured blade to the lawn mower may not result in a frictional interface between the fastening device and the blade to prevent the fastening device from rotating in a releasing direction and disengaging from the lawn mower. Accordingly, a latch for the fastening device is proposed by EP 2 798 937 B1. The proposed latch provides for manually operated latching elements, wherein two levers are pivotably mounted on the blade carrier and are used to release the fastening device. The configuration of the latching elements and levers on the blade carrier is such that these components are exposed to objects encountered by the lawn mower and/or objects propelled by impacting the rotating blade. For example, the design of the fastening device exposes the components to dirt build up on surfaces and clearances of moving parts creating large friction between relative movement of the parts, such as may lead to larger actuating force needed and even loss of intended function. The design of the fastening device likewise exposes the components to various objects (e.g., rocks, gravel, sticks from trees, etc.) which may strike components of the fastening device with considerable force. Accordingly, the latch may be subject to damage and even functional failure, such as may result in the latch no longer being capable of manipulation by hand and/or the latch being unintentionally released allowing the fastening device to become detached from the lawn mower.

Special configurations of quick-connect detachable implements have also been attempted. However, such detachable implements and/or their quick-connect apparatus suffer from a number of drawbacks. For example, quick-connect detachable implements often utilize a special arbor or shape design for torque transmission instead of frictional flange and nut design commonly used, and thus do not provide a backward compatible solution. Moreover, many power tools, such as lawn mowers and brush trimmers, have high demands with respect to a detachable implement (e.g., blades) withstanding shock forces from striking other objects, which often cannot be met by quick-connect detachable implement solutions.

It can be appreciated from the foregoing that existing solutions often are inadequate to facilitate convenient changing of detachable implements utilized with respect to various power tools. For example, it is often inconvenient and sometimes even impossible to change a detachable implement despite the implement having been configured for detachment and reattachment. Even where it is possible to change a detachable implement, it is often inconvenient to do so (e.g., separate tools must be kept up with, force sufficient to cause pain or discomfort to a user's hand must be applied, etc.).

### BRIEF SUMMARY OF THE INVENTION

The present invention is directed to systems and methods which provide force amplified fastener assemblies configured for use with respect to detachable implements for power tools. Force amplified fastener assemblies of embodiments of the invention may implement a gear train configured for giving a mechanical advantage with respect to manual manipulation (e.g., grasping by hand to manually apply tightening or loosening torque) of the fastener assembly. Various force amplifying gear train configurations may, for example, be utilized with respect to a force amplified fastener assembly according to concepts of the present invention to provide a requisite mechanical advantage.

In accordance with embodiments of the invention, a force amplified fastener assembly may comprise planetary gearing disposed within a hand graspable housing to give mechanical advantage with respect to manual fastener tightening and/or loosening forces. Additionally or alternatively, a force amplified fastener assembly of embodiments may comprise cycloidal gearing disposed within a hand graspable housing to give mechanical advantage with respect to manual fastener tightening and/or loosening forces.

Force amplified fastener assemblies of embodiments of the invention may be utilized in place of a conventional lock nut for affixing detachable implements to power tools. For example, force amplified fastener assemblies of embodiments may be used for fixing a blade assembly to a host garden machine (e.g., a lawn mower, a brush cutter, a grass edger, etc.). It should be appreciated, however, that force amplified fastener assemblies provided according to concepts herein may be utilized in a variety of applications and with various host power tool configurations, such as with garden machines which do not have blade implements (e.g., string trimmers) and/or other forms of power tools (e.g., carpentry saws). Irrespective of the particular power tool configuration with which a force amplified fastener assembly is used, the force amplified fastener assembly of embodiments facilitates a user manually, by bare hand, applying force for loosening (e.g., releasing direction) and/or tightening (e.g., fastening direction) the fastener (e.g., for changing a detachable implement). For example, when used in a lawnmower, a force amplified fastener assembly may be operated directly by hand (e.g., tool-free) to achieve cutting blade installation, removal, replacement, and/or the like. Accordingly, a force amplified fastener assembly of embodiments of the invention may provide a tool-free implement change mechanism, whereby changing (e.g., installation, removal, replacement, etc.) of detachable implements with respect to a host power tool is facilitated without aid of separate tools.

Force amplified fastener assemblies of embodiments of the invention may include a lock mechanism operative to lock and/or unlock the force amplified fastener assembly and thus a fastening element thereof. In operation according to embodiments, the fastening element (e.g., a nut or other threaded fastening device) can be rotated in a fastening direction by the force amplified fastener assembly so as to fix, mount, tighten, etc. a blade or other detachable implement onto a motor shaft, wherein this rotation is reversible. That is, the fastening element can be rotated in a releasing direction opposite to the fastening direction so as to loosen, release, etc. the blade or other detachable implement from the motor shaft. A lock mechanism of embodiments may lock the force amplified fastener assembly so that the fastening assembly is not released unwantedly or unintentionally.

A lock mechanism of embodiments of a force amplified fastener assembly may rely upon user action to unlock and/or lock the lock mechanism. For example, a user may squeeze one or more members of a lock mechanism to unlock operation of the locking mechanism for rotation of a force amplified fastener in a releasing direction, otherwise the force amplified fastener assembly may be rotated only in the fastening direction. A lock mechanism lever that is squeezed by a user to unlock operation of the locking mechanism may directly or indirectly interact with the locking interface. For example, a button portion for receiving the user action (e.g., squeezing or depressing) may comprise a lever arm of a lock pawl of a lock mechanism directly inducing unlocking movement. In another example, a button portion for receiving the user action may comprise member separate from a lock pawl of a lock mechanism and indirectly induce unlocking movement (e.g., by engage a lever arm of a lock pawl, by engaging a ring actuator that in turn engages a lock pawl, etc.).

Additionally or alternatively, a lock mechanism of embodiments may be locked and/or unlocked in response to one or more forces other than from user unlocking/locking action.

For example, a lock mechanism of some embodiments may be locked and/or unlocked by centrifugal force (e.g., locked to prevent rotation in the releasing direction while the detachable implement is spinning) or by the force of gravity when the power tool is disposed in a particular orientation (e.g., unlocked when a head of the power tool upon which a detachable implement is fastened is turned upside down for user service). In accordance with some examples, rotation of the detachable implement and corresponding force amplified fastener assembly at a certain speed provides sufficient centrifugal force to encourage pawls of a lock mechanism in the force amplified fastener assembly to engage and lock the fastening element (e.g., nut) to discourage rotation of the force amplified fastener assembly and the fastening element therein in the releasing direction. In accordance with this example, when the power tool is stopped, a bias spring may pull the locking pawl into a disengaged position so user can rotate the force amplified fastener assembly and the fastening element therein in the fastening and/or releasing direction. In accordance with another example, when the force amplified fastener assembly faces to the ground (e.g., the host power tool is in a use orientation), a lock pawl of a lock mechanism thereof is engaged by gravity, whereas when the force amplified fastener assembly faces upward (e.g., the host power tool is in a service orientation) the locking pawl of the lock mechanism is released.

Force amplified fastener assemblies of embodiments of the invention may include one or more features for facilitating a user grasping and manually apply tightening or loosening torque. For example, embodiments of a force amplified fastener assembly may comprise one or more retractable grasping members (e.g., flip-up handle disposable in a storage position and a use position) disposed upon a force amplified fastener assembly (e.g., a face in the fastening/releasing rotation plane of the force amplified fastener assembly) to facilitate a user grasping and manually apply tightening or loosening torque. A retractable grasping member of embodiments may be configured to encourage the grasping member to remain in a storage position during operation of a host power tool. According to further examples, embodiments of a force amplified fastener assembly may additionally or alternatively comprise surface features (e.g., rib structures, surface perturbations, rubberized over-molding, etc.) for facilitating gripping and application of force. Some embodiments may, for example, comprise a cap structure including rib structures and/or other surface perturbations about the periphery of the structure to facilitate a user grasping and manually apply tightening or loosening torque.

Embodiments of force amplified fastener assemblies may be utilized in relatively harsh environments and/or other conditions under which a force amplified fastener assembly, or components thereof, may be subject to abrasive wear, foreign material infiltration, etc. For example, a force amplified fastener assembly may be utilized with respect to a brush cutter, string trimmer, lawn mower, etc., and thus come into contact with various abrasive surfaces (e.g., rocks, concrete, sand, etc.) and/or potentially invasive materials (e.g., soil, mud, sand, etc.). Accordingly, force amplified fastener assemblies of some embodiments may include one or more removable/replaceable exterior surface coverings for providing protection with respect to components of a force amplified fastener assembly. According to some examples, a replaceable jacket presenting a removable/replaceable exterior surface covering some portion of the remainder of a force amplified fastener assembly may be provided. Such a replaceable jacket may present a protective surface to take wear resulting from operation of the host power tool abrasive conditions. Additionally or alternatively, a replaceable jacket may cover or enclose one or more areas of a force amplified fastener assembly to thereby discourage infiltration by foreign material. Force amplified fastener assemblies of some embodiments may include a replaceable cap presenting a removable/replaceable exterior surface covering some portion of the remainder of a force amplified fastener assembly and presenting a protective surface to take wear resulting from operation of the host power tool abrasive conditions. Removable/replaceable exterior surface structures (e.g., replaceable jackets, replaceable caps, etc.) may comprise surface features (e.g., rib structures, surface perturbations, rubberized over-molding, etc.) for facilitating gripping and application of force.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows a portion of a power tool for which a force amplified fastener assembly is provided according to embodiments of the present invention;

FIGS. 2A-2E show various views of a force amplified fastener assembly implementing an exemplary planetary gear train according to embodiments of the present invention;

FIGS. 3A-3E show various views of a force amplified fastener assembly implementing an exemplary cycloid gear train according to embodiments of the present invention;

FIGS. 4A, 4B, 5A, 5B, 6A, 6B, 7A-7F, 8A-8E, 9A, and 9B show details of exemplary lock mechanisms for force amplified fastener assemblies according to embodiments of the present invention;

FIGS. 10A-10C show various view of a grasping member assembly according to embodiments of the present invention; and

FIGS. 11A-11C and 12A-12D show details of exemplary removable/replaceable exterior surface coverings according to embodiments of the present invention.

### DETAILED DESCRIPTION OF THE INVENTION

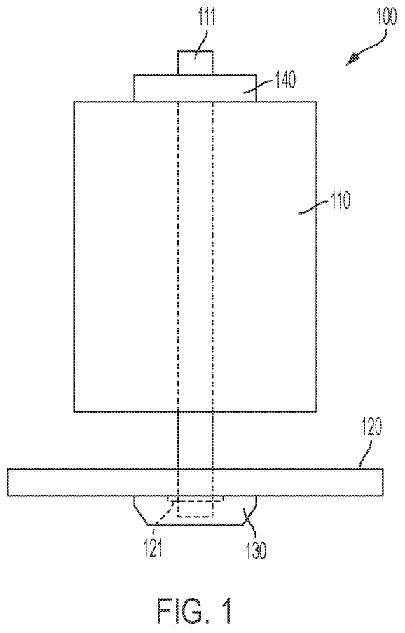

FIG. 1 shows a portion of a power tool configured to utilized detachable implements, wherein a force amplified fastener assembly of embodiments of the present invention is provided to facilitate changing (e.g., installation, removal, replacement, and/or the like) of the detachable implements. Power tool 100 may comprise various configurations of motorized tools configured for performing one or more tasks using corresponding configurations of detachable implement 120. By way of example, power tool 100 of some embodiments may comprise a garden machine in the form of a lawn mower or brush cutter and detachable implement 120 may comprise a cutting blade (e.g., low lift/side-discharge blade, mulching blade, dethatching blade, brush blade, etc.). In accordance with other embodiments, power tool 100 and detachable implement 120 may comprise configurations of a string trimmer and string spool head, leaf blower, cultivator, hedge trimmer blade, and/or brush cutter attachments, a grass edger and edging blade, a carpentry saw and crosscut blade, ripsaw blade, and/or dado blade, etc.

In the example of FIG. 1, power tool 100 comprises motor assembly 110 driving detachable implement 120. Motor assembly 110 of embodiments may comprise various motor configurations. For example, motor assembly 110 of some embodiments may comprise an electric motor, such as a direct current (DC) motor (e.g., brushed motor, brushless motor, etc.) or alternating current (AC) motor (e.g., induction motor, synchronous motor, etc.), powered by batteries, main lines, solar collector, generator, etc. In accordance with some embodiments, motor assembly 110 may comprise an internal combustion motor, such as a gasoline engine or diesel engine, powered by a combustible fuel source.

As shown in the example of FIG. 1, a shaft assembly of motor assembly 110 is utilized to drive detachable implement 120 in operation of power tool 100. Accordingly, in the example of FIG. 1, detachable implement 120 is coupled to a first end of shaft 111 shown passing through the main body of motor assembly 110. It should be appreciated that, although not shown in FIG. 1, the shaft assembly may comprise structure in addition to shaft 111. For example, a shaft assembly of motor assembly 110 may include a mounting or backer plate affixed to shaft 111 for interfacing with detachable implement 120. For example, a mounting or backer plate may be provided to serve as a means by which relative axial motion between the detachable implement and shaft assembly may be prevented or discouraged (e.g., a mounting or backer plate may be configured to provide a clamp-fit interface providing a friction interface using clamping force and/or a form-fit interface providing an interference interface using structures that receive or project into the implement to prevent the relative axial motion). As another example, shaft assembly of motor assembly 110 may include drive gearing and/or a transmission (e.g., providing speed and/or direction control, increased/decreased rotational speed and/or torque, etc.). Accordingly, although the example shown in FIG. 1 shows motor assembly 110 directly driving detachable implement 120, a gear train may be utilized between an output shaft of motor assembly 110 and detachable implement 120 according to embodiments. Irrespective of the particular structure of the shaft assembly of motor assembly 110, detachable implement 120 is removably coupled (e.g., directly or indirectly) to shaft 111 for receiving power from motor assembly 110 in operation of power tool 100.

Force amplified fastener assembly 130 of embodiments of the invention is shown in the example of power tool 100 fastening detachable implement 120 to shaft 111 of motor assembly 110. Force amplified fastener assembly 130 may, for example, be utilized in place of a conventional lock nut (e.g., retrofitting a conventional lock nut in some cases or as an original fastener means in other cases) for affixing detachable implement 120 to power tool 100. In accordance with embodiments of the invention, force amplified fastener assembly 130 facilitates a user manually (e.g., by bare hand) applying force for loosening (e.g., releasing direction) and/or tightening (e.g., fastening direction) force amplified fastener assembly 130 for changing detachable implement 120.

By way of a concrete example for aiding in understanding concepts of the present invention, force amplified fastener assembly 130 of FIG. 1 may be used to replace a blade for a brush cutter or mower (e.g., brush cutter or mower configuration of power tool 100 implementing a blade configuration of detachable implement 120). Manual actuation of force amplified fastener assembly 130 can loosen the fastener assembly and allow for its removal from shaft 111, thereby loosening the blade and facilitating its removal from the brush cutter or mower. When a new blade is to be affixed onto the motor shaft, actuation of force amplified fastener assembly 130 may tighten the fastener assembly on shaft 111 to thereby affixing the blade on the brush cutter or mower.

Force amplified fastener assembly 130 of embodiments of the invention implements a force amplifying gear train configured for giving a mechanical advantage with respect to manual manipulation of the fastener assembly. In operation of a force amplifying gear train of force amplified fastener assembly 130, a force applied by a user (e.g., torque applied in a fastening direction and/or torque applied in a releasing direction) to force amplified fastener assembly 130 (e.g., by grasping a housing of the fastener assembly by hand to manually apply tightening or loosening torque) is increased with respect to its transmission to a fastening element of the fastener assembly. As such, a user may be enabled to apply appreciably more force with respect to rotation of fastening element than would otherwise be possible by the user directly engaging the fastening element.

Various force amplifying gear train configurations may be utilized with respect to force amplified fastener assembly 130 of embodiments to provide a requisite mechanical advantage. According to some embodiments of the invention, force amplified fastener assembly 130 may comprise planetary gearing disposed within a hand graspable housing to give mechanical advantage with respect to manual fastener tightening and/or loosening forces. Additionally or alternatively, force amplified fastener assembly 130 of embodiments may comprise cycloidal gearing disposed within a hand graspable housing to give mechanical advantage with respect to manual fastener tightening and/or loosening forces. The mechanical advantage provided by such force amplifying gear train configurations of embodiments may, for example, provide force amplification on the order of 3-15 times between a manual force applied to a housing of the fastener assembly and a corresponding force applied with respect to a fastening element of the fastener assembly. The force applied to the fastening element as increased by force amplified fastener assembly 130 of embodiments is thus sufficient to overcome static forces of a fastener element seated with appreciable torque (e.g., intentionally, such as to prevent unwanted relative displacement of the detachable implement due to driving forces and/or impacts during use, or unintentionally, such as resulting from inertial tightening in association with application of driving forces). Moreover, force amplifying gear train configurations of embodiments of the invention facilitate implementations of reliable lock mechanisms.

In accordance with embodiments of the invention, force amplified fastener assembly 130 may be manually engaged by a user to fasten and/or unfasten detachable implement 120 from power tool 100 without aid of separate tools. Accordingly, force amplified fastener assembly 130 of embodiments may provide a tool-free implement change configuration.

Embodiments of power tool 100 may be configured for facilitating changing of detachable implement 120 using force amplified fastener assembly 130 without aid of separate tools. For example, power tool 100 may include motor shaft locking apparatus 140 operative cooperatively with force amplified fastener assembly 130 to facilitate changing of detachable implement 120 with respect to power tool 100. In accordance with some examples, motor shaft locking apparatus 140 may be engaged without aid of separate tools to prevent movement of shaft 111 when affixing detachable implement 120 to shaft 111 and/or removing detachable implement 120 from shaft 111. For example, motor shaft locking apparatus 140 may comprise a pin which may be pushed inside an aligned hole in order to lock shaft 111 of power tool 100. According to another example, motor shaft locking apparatus 140 may comprise a one-way bearing that serves as reverse rotational lock with respect to shaft 111. In accordance with yet another example, motor shaft locking apparatus 140 may comprise a locker collar configuration in which a locking collar includes a wide slot section and a narrow slot section configured for selectively allowing and discouraging rotation of shaft 111. For example, in operation of a locker collar of some examples, when shaft 111 is within the wide slot section, shaft 111 and the locking collar do not interface and shaft 111 is free to rotate. However, when the locker collar is slid laterally with respect to shaft 111, shaft 111 is disposed within the narrow slot section such that shaft 111 and the locking collar interface to discourage shaft 111 from rotating (e.g., a portion of shaft 111 disposed in juxtaposition with the locking collar may be provided with a square cross-section configured to cooperate with the narrow slot section of locking collar to interface and discourage rotation of shaft 111 when motor shaft locking apparatus 140 is engaged).

Irrespective of the particular configuration of motor shaft locking apparatus 140, motor shaft locking apparatus 140 may be operable in cooperation with force amplified fastener assembly 130 to facilitate affixing detachable implement 120 to, or removing detachable implement 120 from, the motor shaft assembly of power tool 100 without the use of additional tools according to some embodiments of the invention. For example, an operator of power tool 100 may install and/or remove detachable implement 120 by engaging motor shaft locking apparatus 140 (e.g., through manual manipulation or automatic engagement) and loosening or tightening force amplified fastener assembly 130 through manual manipulation.

It should be appreciated that embodiments of force amplified fastener assembly 130 herein may be utilized with or without further configuration of power tool 100 for facilitating changing of detachable implement 120. For example, some embodiments of force amplified fastener assembly 130 may be utilized without cooperation of a motor shaft locking apparatus (e.g., an implementation of power tool 100 not having motor shaft locking apparatus 140). In one example, a user may manually prevent detachable implement 120 from rotating (e.g., grasping a unsharpened portion, such as a handle portion, of a blade configuration of detachable implement 120 with one hand) while manually manipulating force amplified fastener assembly 130 in a fastening direction or releasing direction with another hand.

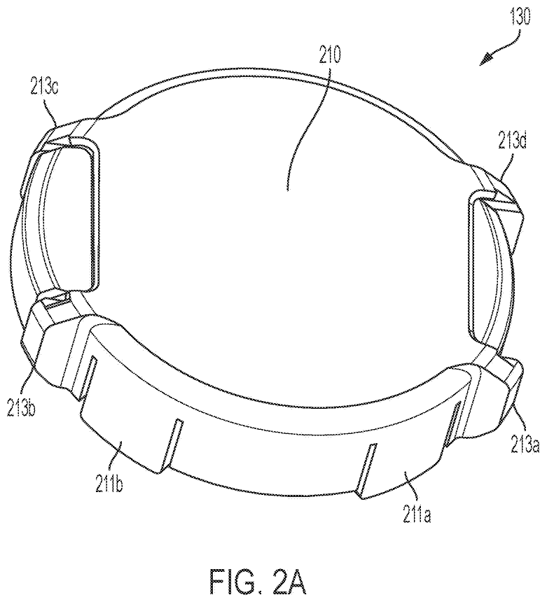

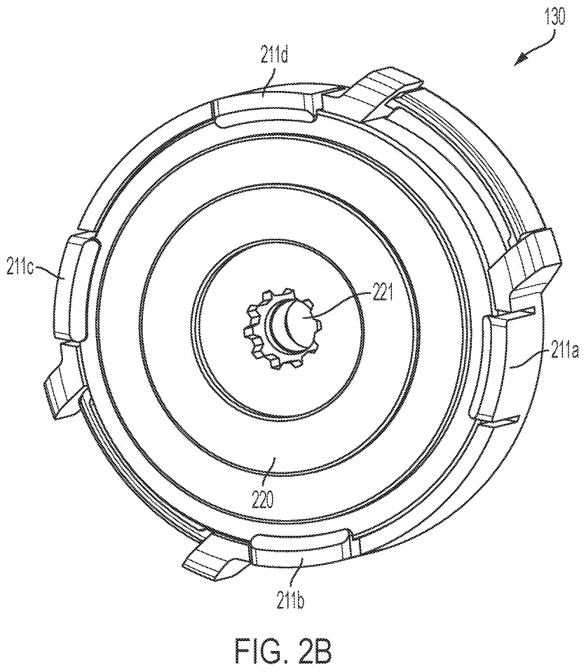

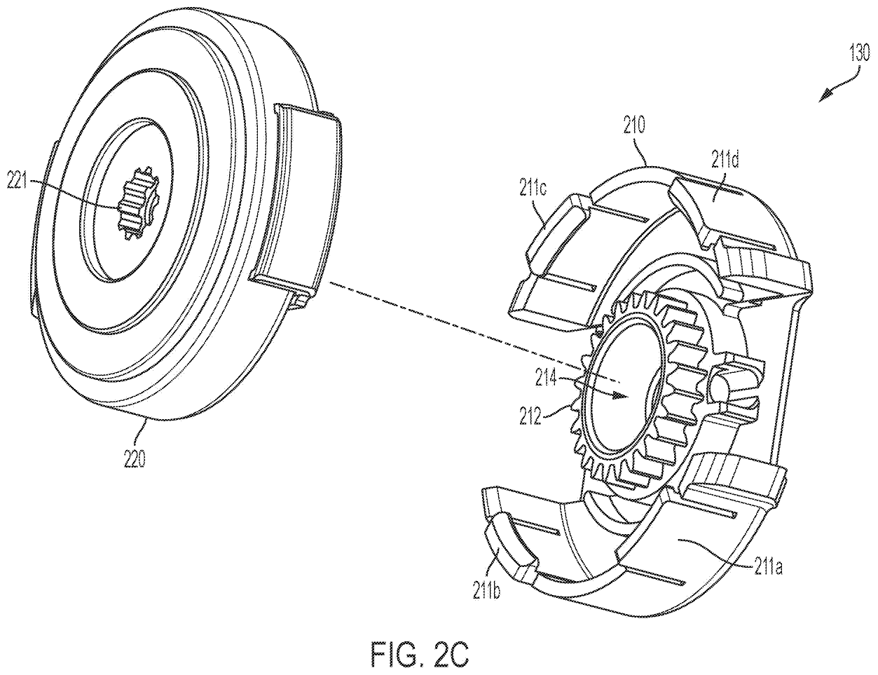

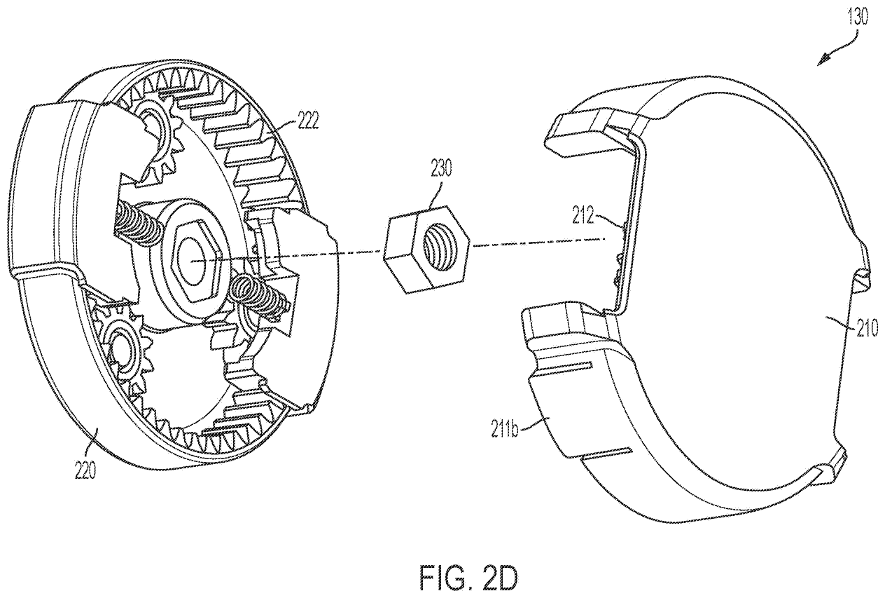

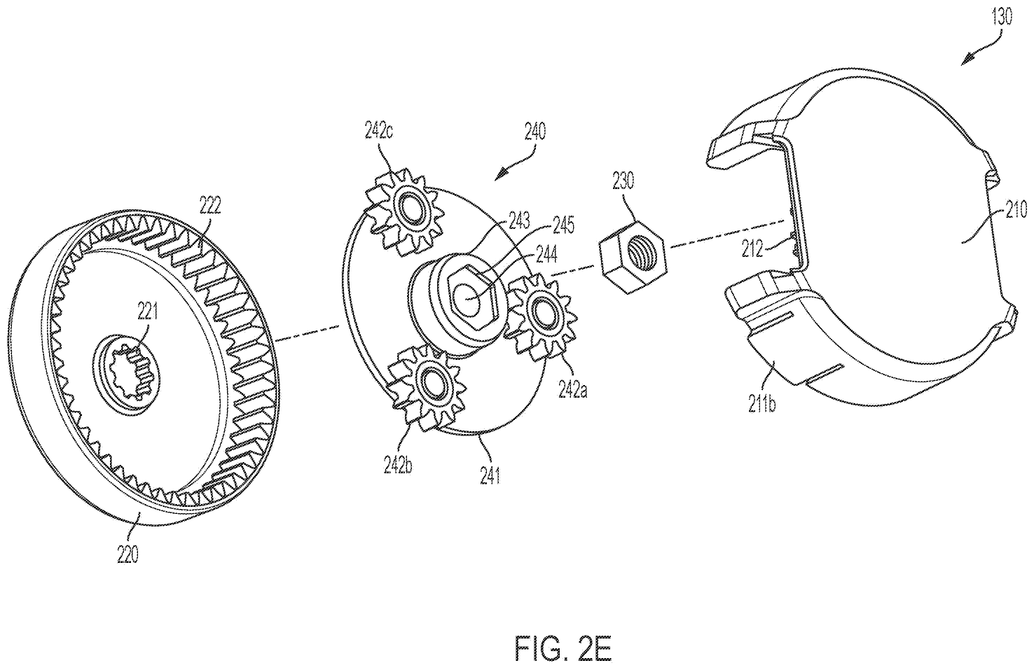

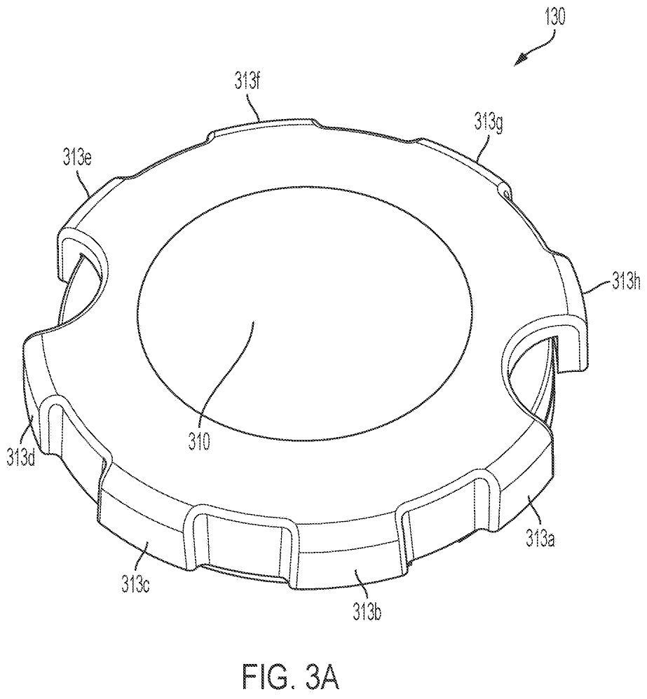

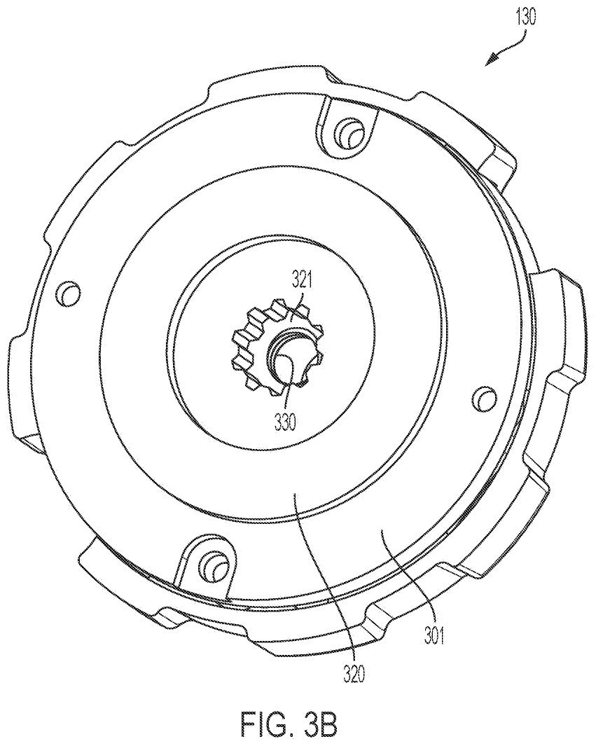

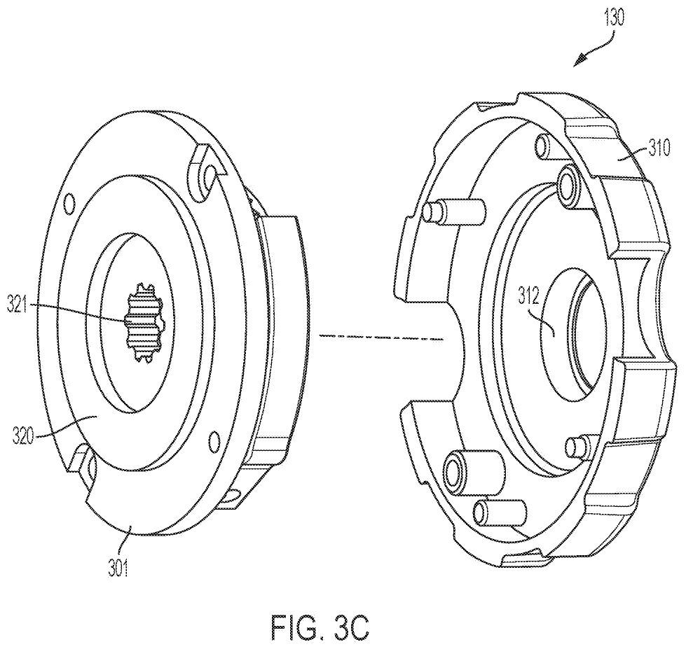

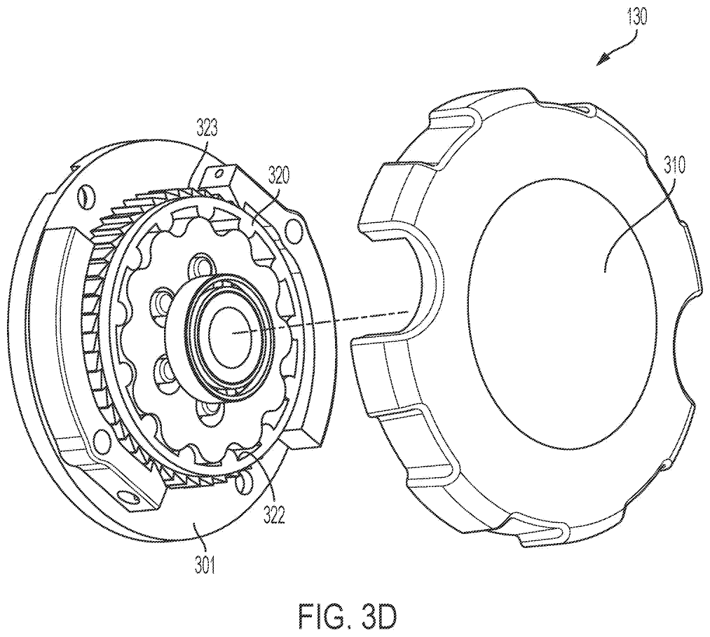

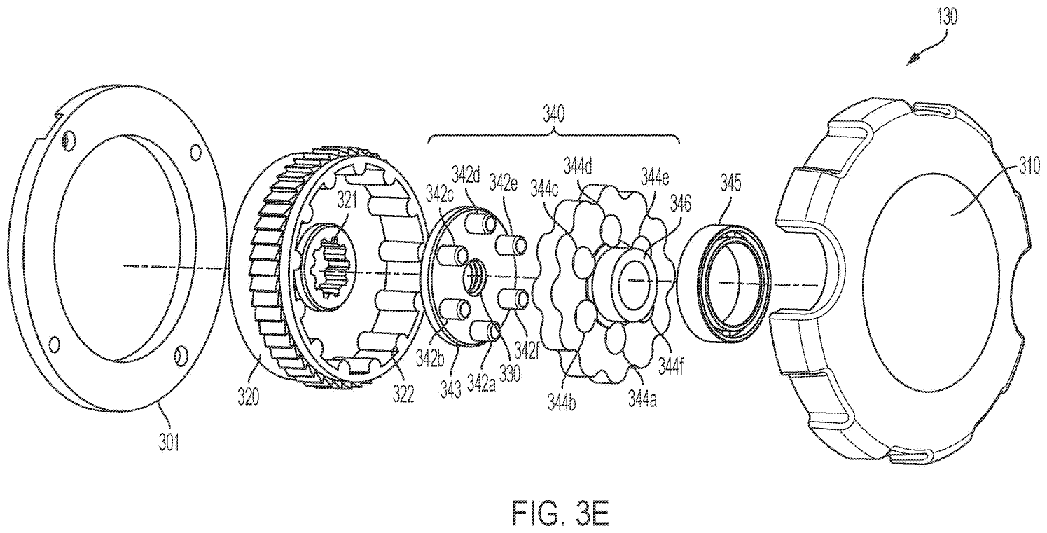

FIGS. 2A-2E and 3A-3E show details with respect to various embodiments of force amplified fastener assembly 130. In particular, FIGS. 2A-2E show details with respect to an embodiment of force amplified fastener assembly 130 implementing a planetary gear configuration for giving a mechanical advantage with respect to manual manipulation of the fastener assembly. Similarly, FIGS. 3A-3E show details with respect to an embodiment of force amplified fastener assembly 130 implementing a cycloid gear configuration for giving a mechanical advantage with respect to manual manipulation of the fastener assembly. Although planetary gear and cycloid gear configurations are shown in the illustrated examples, it should be appreciated that other forms of gear trains (e.g., double reduction gear configurations, reverted gear configurations, etc.) may be utilized in addition to or in the alternative to a planetary gear configuration and/or a cycloid gear configuration. Moreover, multiple types of gearing (e.g., a gear train configuration including a combination of planetary gearing and cycloid gearing) may be utilized in a gear train of some embodiments of force amplified fastener assembly 130.

Reference is first made to the exemplary embodiment of FIGS. 2A-2E in which a planetary gear configuration is implemented. FIGS. 2A and 2B show a planetary gear configuration of an embodiment of force amplified fastener assembly 130 in its assembled state. As shown in the top isometric view of FIG. 2A, the illustrated planetary gear configuration comprises top housing 210. Correspondingly, as shown in the bottom isometric view of FIG. 2B, the illustrated planetary gear configuration comprises bottom structure 220. It should be appreciated that, although the views, housings, and structures are referred to as top and bottom, the designations are relative and there is no limitation that the example force amplified fastener assembly be disposed or utilized in any particular orientation with respect to top and bottom. For example, when utilized with respect to a lawn mower implementation of power tool 100, top housing 210 may be oriented as facing down when installed on shaft 111 and affixing detachable implement 120 in the form of a grass cutting blade to power tool 100.

Top housing 210 and bottom structure 220 are configured for cooperatively incarcerating a planetary gear train and fastening element of the example force amplified fastener assembly. For example, as may be seen in the partially exploded views of FIGS. 2C and 2D, bottom structure 220 may form a cupped structure sized and shaped to nest within a cupped casing formed by top housing 210. In accordance with some examples, the top edge circumference of bottom structure 220 may, when fully nested with top housing 210, terminate at or very near the bottom facing surface of top housing 210, such as for incarcerating components of the planetary gear train and for providing a substantially enclosed area in which infiltration of debris and/or other matter is discouraged. The nested relationship of top housing 210 and bottom structure 220 of embodiments, however, allows for relative rotational movement between the top housing and bottom structure (e.g., top housing 210 may be rotated while bottom structure 220 nested therein is held stationary).

In accordance with the exemplary embodiment, locking tabs 211a-211d of top housing 210 may facilitate bottom structure 220 being slid into a cavity of the cupped casing formed by top housing 210, whereby once bottom structure 220 is fully nested with top housing 210 the locking tabs retain the top housing and bottom structure in the nested relationship. For example, bottom structure 220 of the illustrated embodiment substantially encloses the gap between the bottom edge circumference of top housing 210 and the bottom edge circumference of bottom structure 220, such as to facilitate locking tabs 211a-211d of top housing 210 engaging bottom structure 220 for facilitate retaining the top housing and bottom structure in the nested relationship. Additionally or alternatively such a relationship with respect to the bottom edge circumference of top housing 210 and the bottom edge circumference of bottom structure 220 may be configured to prevent infiltration of debris and/or other matter into the area enclosed by the top housing and bottom structure.

Top housing 210 of embodiments may be configured to facilitate manual manipulation by a user. For example, top housing 210 may be sized and shaped to facilitate grasping by hand so that a user may manually apply torque forces (e.g., torque in fastening and/or releasing directions) to force amplified fastener assembly 130. Additionally or alternatively, top housing 210 may comprise surface features (e.g., rib structure, surface perturbations, rubberized over-molding, etc.) for facilitating gripping and application of force. The illustrated embodiment of top housing 210, for example, includes rib structures 213a-213d disposed about the circumference of the top housing, such as may be utilized to enable and/or enhance a user's grip upon force amplified fastener assembly 130.

Bottom structure 220 of the illustrated embodiment is configured to accept insertion of drive member of a power tool, such as shaft 111 of power tool 100, for facilitating interfacing the drive member with a fastening element of force amplified fastener assembly 130. For example, shaft orifice 221 of the illustrated embodiment of bottom structure 220 may be sized and shaped to accommodate insertion of an end of shaft 111 there through. According to some examples, shaft orifice 221 may be shaped or otherwise be configured (e.g., comprising the undulated circumference of the illustrated embodiment, a square circumference, a hexagonal circumference, etc.) for interfacing with one or more components external to force amplifying fastener assembly 130 (e.g., stay 121 of FIG. 1, as may be disposed upon shaft 111), such as for discouraging or preventing relative rotary movement (e.g., for avoiding unintended unfastening the fastening element as a result of inertial force when the power tool stops or is braked).

Force amplified fastener assembly 130 of the embodiment of FIGS. 2A-2E implements a planetary gear train configured for giving a mechanical advantage with respect to applying tightening or loosening torque to fastening element 230 in response to manual manipulation (e.g., grasping by hand to manually apply torque in a fastening direction or releasing direction) of the fastener assembly. Accordingly, as shown in FIG. 2C, top housing 210 of the example embodiment includes sun gear 212 of the planetary gear train in the illustrated planetary gear configuration of force amplified fastener assembly 130. As shown in FIG. 2D, bottom structure 220 includes ring gear 222 of the exemplary planetary gear train. Planet gear assembly 240, visible in the further exploded view of FIG. 2E (having some components of the exemplary embodiment of force amplified fastener assembly 130 omitted), comprises planet gears 242a-242c which interface between sun gear 212 and ring gear 222 to provide a planetary gearing implementation. In particular, planet gear assembly 240 of the illustrated embodiment is received within a cavity of the cupped structure formed by bottom structure 220, whereby once bottom structure 220 is fully nested with top housing 210 planet gears 242a-242c are incarcerated within an interior area of the top housing and bottom structure and provide a geared interface between sun gear 212 and ring gear 222.

In accordance with embodiments, sun gear 212 is affixed to or formed as part of top housing 210 and ring gear 222 is affixed to or formed as part of bottom structure 220. Accordingly, when top housing 210 is rotated (e.g., in response to a user manually applying a torque force thereto), sun gear 212 of embodiments will correspondingly be rotated. Similarly, ring gear 222 rotates or does not rotate in correspondence with bottom structure 220. The incarcerated relationship of planet gear assembly 240 within the interior area of bottom structure 220 nested within top housing 210 allows for relative rotational movement of gear plate 241 with respect to the top housing and bottom structure. For example, top housing 210 may be rotated with bottom structure 220 nested therein held stationary and gear plate 241 may rotate at a different speed than top housing 210. That is, rotation of top housing 210 and thus sun gear 212 meshed with planet gears 242a-242c causes the planet gears to rotate oppositely, whereby planet gears 242a-242c meshed with ring gear 222 held stationary by bottom structure 220 results in gear plate 241 rotating in the direction of top housing 210/sun gear 212, albeit at a reduced rotational rate and having a higher torque force.

Planet gear assembly 240 includes fastening element housing 243 configured for accepting fastening element 230 in coaxial correspondence with shaft orifice 221. Accordingly, fastening element housing 243 of the illustrated embodiment includes shaft orifice 244 sized and shaped to accommodate insertion of an end of shaft 111 there through, whereby a fastening element disposed within receiver cavity 245 of fastening element housing 243 may interface with shaft 111. The illustrated embodiment of fastening element housing 243 is sized and shaped to extend into and nest within an inner circumference of sun gear 212 when planet gear assembly 240 is incarcerated within the nested top housing and bottom structure. Accordingly, fastening element 230 disposed in receiver cavity 245 may be captured in a space between fastening element housing 243 and top housing 210 of embodiments of the invention.

Fastening element housing 243 may be affixed to or formed as part of gear plate 241 of the illustrated embodiment. Accordingly, when gear plate 241 rotates, fastening element housing 243 of embodiments will correspondingly be rotated. Receiver cavity 245 of embodiments is configured to encourage fastening element 230 to rotate in correspondence with gear plate 241. Fastening element 230 of embodiments may comprise a nut or other threaded fastening device configured to be rotated in a fastening direction and a releasing direction upon a drive member. For example, the illustrated embodiment of fastening element 230 comprises a nut appropriately threaded to engage an end of shaft 111 of power tool 100, such as may be utilized to fix, mount, tighten, etc. detachable implement 120 onto shaft 111. Accordingly, receiver cavity 245 of fastening element housing 243 of the illustrated embodiment is shaped to receive fastening element 230 and to provide control of movement thereof relative to shaft 111. For example, the illustrated embodiment of receiver cavity 245 comprises a hexagon circumference corresponding to the shape of the example nut implementation of fastening element 230.

Although fastening element 230 of the example illustrated in FIGS. 2A-2E is described as disposed in receiver cavity 245 of fastening element housing 243 on gear plate 241, it should be appreciated that other configurations of fastening elements may be utilized according to embodiments of the invention. For example, rather than a separate component (e.g., nut) providing fastening element 230, some embodiments of fastening element 230 may be formed integral to another component of force amplified fastener assembly 130. As a specific example, fastening element 230 may be formed as suitably threaded portion of shaft orifice 244 sized and shaped to correspond to the size and shape of the end of shaft 111.

In operation of force amplified fastener assembly 130 of the embodiment of FIGS. 2A-2E, when shaft 111 is inserted through orifices 221 and 244 and interfaces with fastener element 230, top housing 210 may be grasped by the hand of a user and rotated in a fastening direction or a releasing direction to correspondingly rotate fastener element 230 relative to shaft 111. Sun gear 212, planet gears 242a-242c, and ring gear 222 of the planetary gear train provide a mechanical advantage with respect to applying tightening or loosening torque to fastening element 230. That is, a mechanical advantage corresponding to the size relationship between sun gear 212 and planet gears 242a-242c (e.g., on the order of 3-5 times) may be implemented between the torque manually applied to top housing 210 and the resultant torque applied to fastener element 230.

Having described an embodiment of force amplified fastener assembly 130 implementing a planetary gear train, reference is now made to the exemplary embodiment of FIGS. 3A-3E in which a cycloid gear configuration is implemented. FIGS. 3A and 3B show a cycloid gear configuration of an embodiment of force amplified fastener assembly 130 in its assembled state. As shown in the top isometric view of FIG. 3A, the illustrated cycloid gear configuration comprises top housing 310. Correspondingly, as shown in the bottom isometric view of FIG. 3B, the illustrated cycloid gear configuration comprises bottom structure 320. It should be appreciated that, although the views, housings, and structures are referred to as top and bottom, the designations are relative and there is no limitation that the example force amplified fastener assembly be disposed or utilized in any particular orientation with respect to top and bottom. For example, when utilized with respect to a lawn mower implementation of power tool 100, top housing 310 may be oriented as facing down when installed on shaft 111 and affixing detachable implement 120 in the form of a grass cutting blade to power tool 100.

Top housing 310 and bottom structure 320 are configured for cooperatively incarcerating a cycloid gear train and fastening element of the example force amplified fastener assembly. For example, as may be seen in the partially exploded views of FIGS. 3C-3E, bottom structure 320 may form a cupped structure sized and shaped to nest within a cupped casing formed by top housing 310. In accordance with some examples, the top edge circumference of bottom structure 320 may, when fully nested with top housing 310, terminate at or very near the bottom facing surface of top housing 310, such as for incarcerating components of the cycloid gear train and for providing a substantially enclosed area in which infiltration of debris and/or other matter is discouraged. The nested relationship of top housing 310 and bottom structure 320 of embodiments allows for relative rotational movement between the top and bottom structures (e.g., top housing 310 may be rotated while bottom structure 320 nested therein is held stationary).

As can be seen in FIGS. 3A-3E, the example cycloid gear configuration of force amplified fastener assembly 130 comprises bottom housing 301 configured to enclose components of the gear train and/or a lock mechanism used therewith within the cupped structure of top housing 310. Bottom housing 301 of the illustrated example comprises a substantially planar bottom housing that may be affixed by various fastening means (e.g., screws, adhesive, welding, locking tabs, etc.) to top housing 310 to enclose some or all of the area within the concavity of the top housing cupped structure. Bottom structure 320 may, for example, be incarcerated by bottom housing 301 whereby at least a portion of bottom structure 320 is disposed within the concavity of the top housing cupped structure. In accordance with embodiments of the invention, bottom structure 320 is free to rotate axially with respect to top housing 310 and bottom housing 301 affixed to top housing 310.

In the illustrated example, bottom structure 320 is sized so as to provide clearance with respect to components of an embodiment of a lock mechanism (described in detail below). The configuration of bottom housing 301 may provide a skirting flange and/or other structure to substantially enclose the gap between the bottom edge circumference of top housing 310 and the bottom edge circumference of bottom structure 320, such as to prevent infiltration of debris and/or other matter into the area of the lock mechanism and/or to facilitate retaining the top housing and bottom structure in the nested relationship.

Top housing 310 of embodiments may be configured to facilitate manual manipulation by a user. For example, top housing 310 may be sized and shaped to facilitate grasping by hand so that a user may manually apply torque forces (e.g., torque in fastening and/or releasing directions) to force amplified fastener assembly 130. Additionally or alternatively, top housing 310 may comprise surface features (e.g., rib structure, surface perturbations, rubberized over-molding, etc.) for facilitating gripping and application of force. The illustrated embodiment of top housing 310, for example, includes rib structures 313a-313h disposed about the circumference of the top housing, such as may be utilized to enable and/or enhance a user's grip upon force amplified fastener assembly 130.

Bottom structure 320 of the illustrated embodiment is configured to accept insertion of drive member of a power tool, such as shaft 111 of power tool 100, for facilitating interfacing the drive member with a fastening element of force amplified fastener assembly 130. For example, shaft orifice 321 of the illustrated embodiment of bottom structure 320 may be sized and shaped to accommodate insertion of an end of shaft 111 there through. According to some examples, shaft orifice 321 may be shaped or otherwise be configured (e.g., comprising the undulated circumference of the illustrated embodiment, a square circumference, a hexagonal circumference, etc.) for interfacing with one or more components external to force amplifying fastener assembly 130 (e.g., stay 121 of FIG. 1, as may be disposed upon shaft 111), such as for discouraging or preventing relative rotary movement (e.g., for avoiding unintended unfastening the fastening element as a result of inertial force when the power tool stops or is braked).

Force amplified fastener assembly 130 of the embodiment of FIGS. 3A-3E implements a cycloid gear train configured for giving a mechanical advantage with respect to applying tightening or loosening torque to fastening element 330 in response to manual manipulation (e.g., grasping by hand to manually apply torque in a fastening direction or releasing direction) of the fastener assembly. Accordingly, as shown in FIG. 3C, top housing 310 of the example embodiment includes eccentric receiver 312 configured for providing eccentric rotation of shaft 346 of the cycloid gear train in the illustrated cycloid gear configuration of force amplified fastener assembly 130. Eccentric receiver 312 of embodiments is disposed slightly off-center within the bottom facing surface of top housing 310, whereby as top housing 310 is rotated eccentric receiver 312 rotates about or orbits a central point of the bottom facing surface. As shown in FIG. 3D, bottom structure 320 includes ring gear 322 of the exemplary cycloid gear train. Cycloid gear assembly 340, visible in the further exploded view of FIG. 3E (having some components of the exemplary embodiment of force amplified fastener assembly 130 omitted), interfaces between eccentric receiver 312 and ring gear 322 to provide a cycloid gearing implementation. Cycloid gear assembly 340 of the illustrated embodiments comprises cycloidal disk 341 and roller pins 342a-342f disposed on pin plate 343, wherein roller pins 342a-342f are inserted in corresponding ones of orifices 344a-344f of cycloidal disk 341 when cycloid gear assembly 340 is assembled. Shaft 346 of cycloidal disk 341 interfaces with eccentric receiver 312 via bearing 345 of the illustrated embodiment. Cycloid gear assembly 340 of the illustrated embodiment is received within a cavity of the cupped structure formed by bottom structure 320, whereby once bottom structure 320 is fully nested with top housing 310 cycloid gear assembly 340 is incarcerated within an interior area of the top and bottom structures and provide an interface between eccentric receiver 312 and ring gear 322.

In accordance with embodiments, eccentric receiver 312 is formed as part of or otherwise affixed to top housing 310 and ring gear 322 is affixed to or formed as part of bottom structure 320. Accordingly, when top housing 310 is rotated (e.g., in response to a user manually applying a torque force thereto), eccentric receiver 312 of embodiments will correspondingly be rotated eccentrically (e.g., rotating about a center point of the bottom surface of top housing 310), correspondingly eccentrically rotating cycloid gear assembly 340 via shaft 346. Similarly, ring gear 322 rotates or does not rotate in correspondence with bottom structure 320. The incarcerated relationship of cycloid gear assembly 340 within the interior area of bottom structure 320 nested within top housing 310 allows for relative rotational movement of pin plate 343 with respect to the top housing and bottom structure. For example, top housing 310 may be rotated with bottom structure 320 nested therein held stationary and pin plate 343 may rotate at a different speed than top housing 310. That is, rotation of top housing 310 and thus eccentric receiver 312 interfaced with cycloidal disk 341 causes the cycloidal disk to rotate correspondingly in an eccentric motion, whereby cycloidal disk 341 meshed with the lobes of ring gear 322 held stationary by bottom structure 320 engages roller pins 342a-342f via orifices 344a-344f to transfer rotational force to pin plate 343, albeit at a reduced rotational rate and having a higher torque force.

Cycloid gear assembly 340 includes fastening element 330 disposed in coaxial correspondence with shaft orifice 321. For example, the illustrated embodiment of fastening element 330 comprises a portion of an orifice in pin plate 343 that is sized and shaped to correspond to the size and shape of an end of shaft 111 of power tool 100 and is appropriately threaded to engage the end of shaft 111, such as may be utilized to fix, mount, tighten, etc. detachable implement 120 onto shaft 111. Accordingly, fastening element 330 of the illustrated embodiment comprises a threaded fastening device formed integral to another component of force amplified fastener assembly 130 and is configured to be rotated in a fastening direction and a releasing direction upon a drive member.

Although fastening element 330 of the example illustrated in FIGS. 3A-3E is described as being formed integral to pin plate 343, it should be appreciated that other configurations of fastening elements may be utilized according to embodiments of the invention. For example, rather than a portion of another component being configured to provide fastening element 330, some embodiments of fastening element 330 may comprise a separate component (e.g., nut). For example, a fastening element housing may be affixed to or formed as part of pin plate 343 and may have a shaft orifice sized and shaped to accommodate insertion of an end of shaft 111 there through, whereby a fastening element may be disposed within a receiver cavity of the fastening element housing.

In operation of force amplified fastener assembly 130 of the embodiment of FIGS. 3A-3E, when shaft 111 is inserted through orifice 321 and interfaces with fastener element 330, top housing 310 may be grasped by the hand of a user and rotated in a fastening direction or a releasing direction to correspondingly rotate fastener element 330 relative to shaft 111. Eccentric receiver 312, cycloidal disk 341, ring gear 322, and roller pins 342a-342f of the cycloid gear train provide a mechanical advantage with respect to applying tightening or loosening torque to fastening element 330. That is, a mechanical advantage corresponding to the relationship between the number of lobes on the cycloidal disk and the ring gear (e.g., on the order of 3-15 times) may be implemented between the torque manually applied to top housing 310 and the resultant torque applied to fastener element 330.

As can be appreciated from the foregoing, force amplified fastener assembly 130 is configured according to embodiments of the invention to provide appreciable mechanical advantage with respect to rotating a fastening element through implementation of a force amplifying gear train configuration. In accordance with aspects of the invention, a user may be enabled to manually apply tightening or loosening torque by hand sufficient to impart a friction interface between force amplified fastener assembly 130 and a corresponding detachable implement so as to prevent unwanted relative displacement of the detachable implement during use of the power tool, to overcome increased frictional interfacing resulting from inertial tightening of the amplified fastener assembly during use of the power tool, and/or to prevent unwanted loosening or separation of the force amplified fastener assembly during use of the power tool. For example, force amplified fastener assembly 130 of embodiments may facilitating tightening a fastening element thereof sufficiently by hand to retain a detachable implement upon a reversible power tool such that relative motion of the detachable implement is held to below 15° in either direction upon application of torque applied to the detachable implement by operation of the power tool.

Force amplified fastener assembly 130 of some embodiments of the invention may include a lock mechanism operative to lock and/or unlock the force amplified fastener assembly and thus a fastening element thereof. For example, a lock mechanism of embodiments may be used in addition to or in the alternative to the above mentioned friction interface between force amplified fastener assembly 130 and detachable implement 120 to prevent unwanted relative displacement of the detachable implement. Accordingly, in operation according to some examples, a lock mechanism may be utilized to lock force amplified fastener assembly 130 so that the fastening assembly is not released unwantedly or unintentionally. For example, a locking mechanism of embodiments of the invention may provide locking with respect to movement of a top housing relative to a bottom structure of a force amplified fastener assembly, whereby undesired rotation of a fastening element in a fastening direction and/or a releasing direction may be prevented. Such embodiments of a locking mechanism may thus act indirectly upon the fastening element for preventing unwanted rotation in one or more directions. Additionally or alternatively, a lock mechanism of embodiments of the invention may act directly upon a fastening element, such as by directly interfacing with one or more surfaces thereof to prevent unwanted rotation in one or more directions.

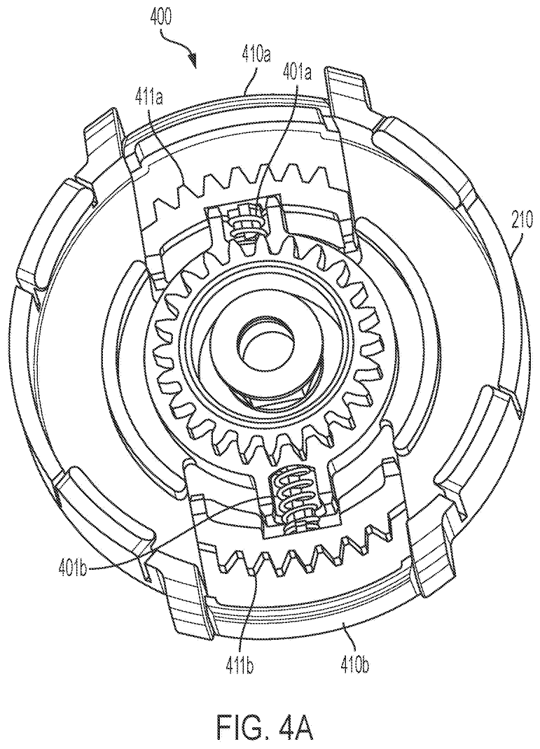

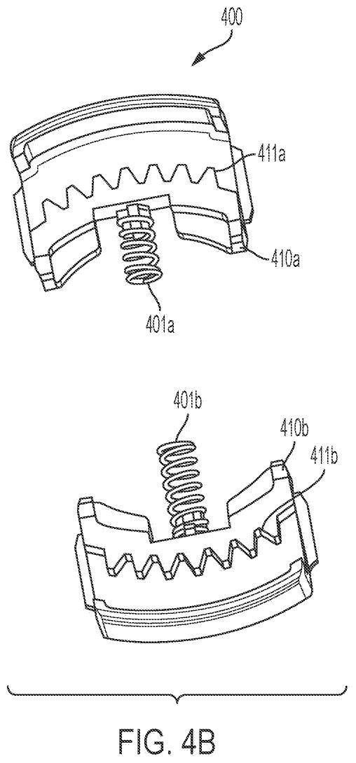

FIGS. 4A and 4B show details with respect to an exemplary lock mechanism implemented with respect to the planetary gear train configuration of the embodiment of FIGS. 2A-2E. Lock mechanism 400 of the example illustrated in FIGS. 4A and 4B includes lock elements 410a and 410b disposed in the underside of top housing 210. Lock elements 410a and 410b are configured for engaging bottom structure 220 (FIG. 2D) and provide locking with respect to movement of top housing 210 relative to bottom structure 220 of force amplified fastener assembly 130. For example, lock elements 410a and 410b of the illustrated embodiment include teeth 411a and 411b, respectively, configured for interfacing with the teeth of ring gear 222 (FIG. 2D) of bottom structure 220. Lock elements 410a and 410b may, for example, be slidably coupled to the underside surface of top housing 210, whereby when the lock elements are slid radially outward teeth 411a and 411b engage the teeth of ring gear 222 and prevent movement of top housing 210 relative to bottom structure 220. Further, lock elements 410a and 410b may be slid radially inward to a point that teeth 411a and 411b clear the teeth of ring gear 222 and movement of top housing 210 relative to bottom structure 220 is permitted.

Lock elements 410a and 410b of embodiments of lock mechanism 400 may utilize user action to unlock and/or lock the lock mechanism. Springs 401a and 401b may, for example, provide a bias force to hold lock elements 410a and 410b, respectively, in a radially outward position (e.g., lock mechanism 400 in a locked state). A user may apply a force (e.g., squeezing force) to a portion of lock elements 410a and 410b accessible via corresponding openings in top housing 210 to cause the lock elements to slide radially inward (e.g., lock mechanism 400 in an unlocked state) to disengage the lock mechanism. Alternatively, lock elements of lock mechanism 400 may be configured to move between locked and unlocked positions in response to one or more forces other than from user unlocking/locking action. For example, weighted pivot members may be provided with respect to lock elements 410a and 410b, whereby weights disposed at ends of the weighted pivot members may be acted on by centrifugal force to encourage lock elements 410a and 410b to move radially outward (e.g., placing lock mechanism 400 in a locked state) when power tool 100 is operating. Bias springs and/or gravity may be utilized to encourage the weighted pivot members to encourage lock elements 410a and 410b to move radially inward (e.g., placing lock mechanism 400 in an unlocked state) when power tool 100 is not operating or is disposed in a service orientation.

In operation according to the illustrated embodiment of lock mechanism 400, movement of top housing 210 relative to bottom structure 220 when lock mechanism 400 is in a locked state is prevented in both the fastening direction and the releasing direction. For example, teeth 411a and 411b are sized and shaped to correspond to the size and shape of the teeth of ring gear 222 to thereby provide a locking engagement (e.g., when lock elements 410a and 410b are in a radially outward position) which discourages rotation in either direction. Alternative embodiments may, however, provide different configurations of teeth 411a and 411b, such as to facilitate preventing movement of top housing 210 relative to bottom structure 220 in a first direction (e.g., releasing direction) when lock elements 410a and 410b are in a radially outward position while allowing movement of top housing 210 relative to bottom structure 220 in a second direction (e.g., fastening direction) when lock elements 410a and 410b are in a radially outward position. For example, teeth 411a and 411b may be provided in a saw-tooth type configuration, wherein a ramped side of the saw-teeth permits relative movement of top housing 210 with respect to bottom structure 220 in a first direction and a bulkhead side prevents relative movement of top housing with respect to bottom structure 220 in a second direction. In the illustrated example, movement of top housing 210 relative to bottom structure 220 is prevented in the releasing direction but not the fastening direction.

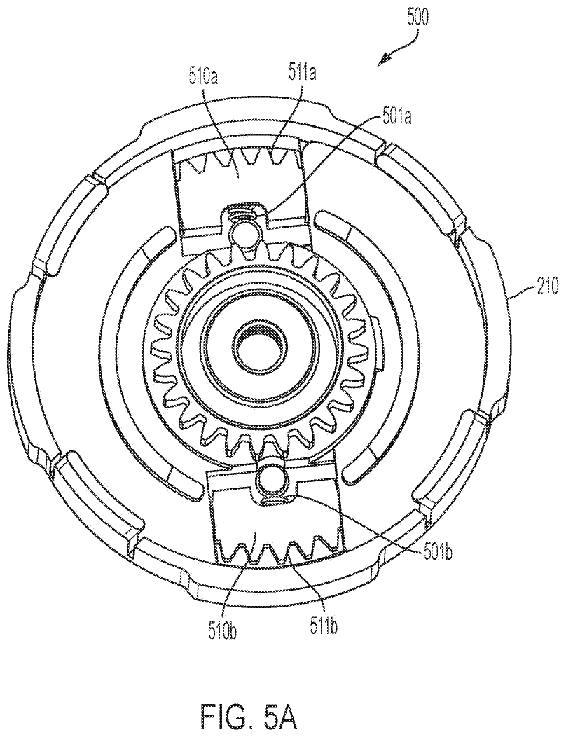

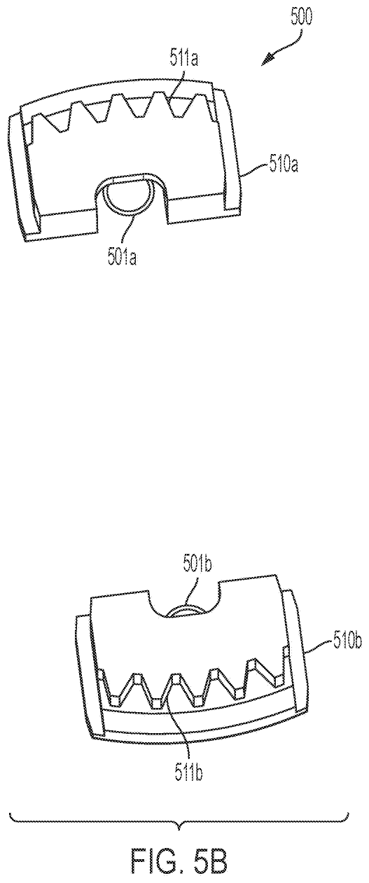

FIGS. 5A and 5B show details with respect to another exemplary lock mechanism as may be implemented with respect to the planetary gear train configuration of the embodiment of FIGS. 2A-2E. Lock mechanism 500 of the example illustrated in FIGS. 5A and 5B includes lock elements 510a and 510b disposed in the underside of top housing 210. Lock elements 510a and 510b are configured for engaging bottom structure 220 (FIG. 2D) and provide locking with respect to movement of top housing 210 relative to bottom structure 220 of force amplified fastener assembly 130. For example, lock elements 510a and 510b of the illustrated embodiment include teeth 511a and 511b, respectively, configured for interfacing with the teeth of ring gear 222 (FIG. 2D) of bottom structure 220. Lock elements 510a and 510b may, for example, be slidably coupled to the underside surface of top housing 210, whereby when the lock elements are slid radially outward teeth 511a and 511b engage the teeth of ring gear 222 and prevent movement of top housing 210 relative to bottom structure 220. Further, lock elements 510a and 510b may be slid radially inward to a point that teeth 511a and 511b clear the teeth of ring gear 222 and movement of top housing 210 relative to bottom structure 220 is permitted.

Lock elements 510a and 510b of embodiments of lock mechanism 500 may move between locked and unlocked positions in response to various forces, such as centrifugal force and/or the force of gravity. For example, lock mechanism 500 may be placed in a locked state to prevent rotation in the releasing direction while the detachable implement is spinning sufficiently rapidly to cause lock elements 510a and 510b to slide outward and cause teeth 511a and 511b to engage the teeth of ring gear 222. In accordance with the illustrated example, lock elements 510a and 510b are weighted sufficiently to cause the lock elements to overcome the tension bias of springs 501a and 501b slide such that teeth 511a and 511b move outward and engage the teeth of ring gear 222 in response to centrifugal force resulting from rotation of the detachable implement and corresponding force amplified fastener assembly at a sufficient speed. In accordance with this example, when power tool 100 is stopped, a springs 501a and 501b may provide bias forces to pull lock elements 510a and 510b such that they are slid sufficiently inward for teeth 511a and 511b to disengage the teeth of ring gear 222. Additionally or alternatively, lock mechanism 500 may be placed in an unlocked state by the force of gravity to allow rotation in the releasing direction when power tool 100 is disposed in a particular orientation (e.g., unlocked when a head of the power tool upon which a detachable implement is fastened is turned upside down for user service). According to some embodiments, lock mechanism 500 may additionally or alternatively utilize user action to unlock and/or lock the lock mechanism. Springs 501a and 501b may, for example, be disposed to provide a bias force to hold lock elements 510a and 510b, respectively, such that teeth 511a and 511b are disposed in a radially outward position (e.g., lock mechanism 500 in a locked state). A user may apply a force (e.g., squeezing force) to a portion of lock elements 510a and 510b (e.g., pressing the lock elements) made accessible via corresponding openings in top housing 310 to cause the lock elements to slide such that teeth 511a and 511b move radially inward (e.g., lock mechanism 500 in an unlocked state) to disengage the lock mechanism.

In operation according to the illustrated embodiment of lock mechanism 500, movement of top housing 210 relative to bottom structure 220 when lock mechanism 500 is in a locked state is prevented in both the fastening direction and the releasing direction. For example, teeth 511a and 511b are sized and shaped to correspond to the size and shape of the teeth of ring gear 222 to thereby provide a locking engagement (e.g., when lock elements 510a and 510b are in a radially outward position) which discourages rotation in either direction. Alternative embodiments may, however, provide different configurations of teeth 511a and 511b, such as to facilitate preventing movement of top housing 210 relative to bottom structure 220 in a first direction (e.g., releasing direction) when lock elements 510a and 510b are in a radially outward position while allowing movement of top housing 210 relative to bottom structure 220 in a second direction (e.g., fastening direction) when lock elements 510a and 510b are in a radially outward position. For example, teeth 511a and 511b may be provided in a saw-tooth type configuration, wherein a ramped side of the saw-teeth permits relative movement of top housing 210 with respect to bottom structure 220 in a first direction and a bulkhead side prevents relative movement of top housing 210 with respect to bottom structure 220 in a second direction. In the illustrated example, movement of top housing 210 relative to bottom structure 220 is prevented in the releasing direction but not the fastening direction.

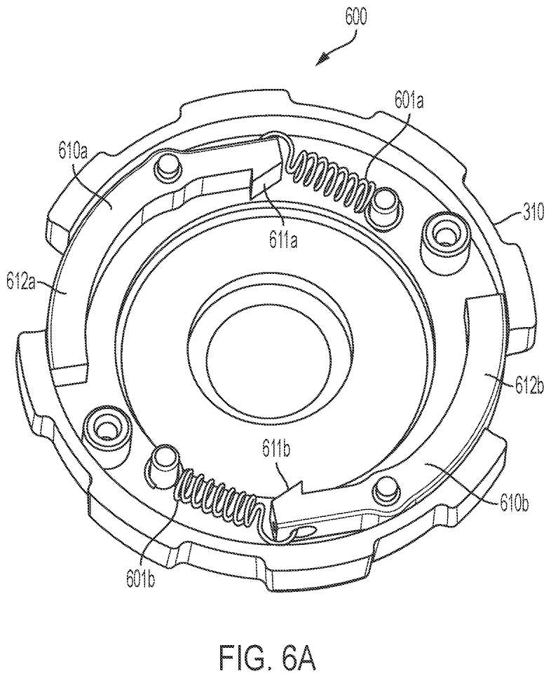

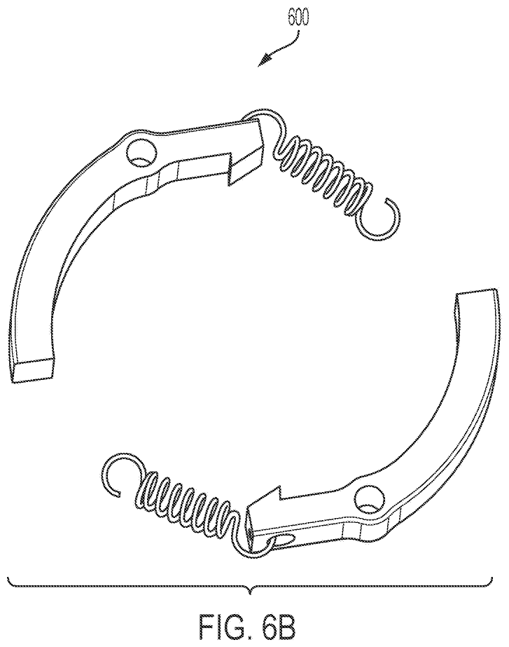

FIGS. 6A and 6B show details with respect to an exemplary lock mechanism implemented with respect to the cycloid gear train configuration of the embodiment of FIGS. 3A-3E. Lock mechanism 600 of the example illustrated in FIGS. 6A and 6B includes lock elements 610a and 610b disposed in the underside of top housing 310. Lock elements 610a and 610b are configured for engaging bottom structure 320 (FIG. 3D) and provide locking with respect to movement of top housing 310 relative to bottom structure 320 of force amplified fastener assembly 130. For example, lock elements 610a and 610b of the illustrated embodiment include teeth 611a and 611b, respectively, configured for interfacing with teeth 323 (FIG. 3D) disposed upon an outer circumference of ring gear 322 of bottom structure 220. Lock elements 610a and 610b may, for example, comprise pawls pivotally coupled to the underside surface of top housing 310, whereby when the lock elements are pivoted such that teeth 611a and 611b move radially inward such that the teeth engage teeth 323 of ring gear 322 and prevent movement of top housing 310 relative to bottom structure 320. Further, lock elements 610a and 610b may be pivoted radially outward to a point that teeth 611a and 611b clear teeth 323 of ring gear 322 and movement of top housing 310 relative to bottom structure 320 is permitted.

Lock elements 610a and 610b of embodiments of lock mechanism 600 may utilize user action to unlock and/or lock the lock mechanism. Springs 601a and 601b may, for example, provide a bias force to hold lock elements 610a and 610b, respectively, in a radially inward position (e.g., lock mechanism 600 in a locked state). A user may apply force (e.g., squeezing force) to a button portion of arms 612a and 612b of lock elements 610a and 610b, respectively, accessible via corresponding openings in top housing 310 to cause the lock elements to pivot between locked and unlocked positions (e.g., lock mechanism in an unlocked state) to disengage the lock mechanism. Additionally or alternatively, lock elements of lock mechanism 600 may be configured to move between locked and/or unlocked positions in response to one or more forces other than from user unlocking/locking action. For example, arms 612a and 612b may be weighted, whereby the weighted pivot members may be acted on by centrifugal force to encourage lock elements 610a and 610b to pivot (e.g., placing lock mechanism 600 in a locked state) when power tool 100 is operating. Lock mechanism 600 of some embodiments may be placed in an unlocked state by the force of gravity to allow rotation in the releasing direction when power tool 100 is disposed in a particular orientation (e.g., unlocked when a head of the power tool upon which a detachable implement is fastened is turned upside down for user service).

In operation according to the illustrated embodiment of lock mechanism 600, movement of top housing 310 relative to bottom structure 320 when lock mechanism 600 is in a locked state is prevented in the releasing direction while movement in the fastening direction is permitted. For example, teeth 611a and 611b and teeth 323 of the illustrated embodiment are provided in saw-tooth type configurations, wherein a ramped side of the saw-teeth permits relative movement of top housing 310 relative to bottom structure 320 in a first direction and a bulkhead side prevents relative movement of top housing 310 relative to bottom structure 320 in a second direction. In the illustrated example, movement of top housing 310 relative to bottom structure 320 is prevented in the releasing direction but not the fastening direction. Alternative embodiments of lock mechanism 600 may be configured to prevent movement of top housing 310 relative to bottom structure 320 in both the fastening direction and releasing direction when lock mechanism 600 is in a locked state. For example, teeth 611a and 611b and teeth 323 may be correspondingly sized and shaped to provide a locking engagement (e.g., when lock elements 610a and 610b are pivoted such that teeth 611a and 611b engage teeth 323) which discourages rotation in either direction.

According to examples of lock mechanism 600 above, lock elements 610a and 610b, which are manipulated by the user (e.g., button portions thereof squeezed), themselves provide the locking interface with bottom structure for locking movement of top housing 310 relative to bottom structure 320 of force amplified fastener assembly 130. That is, a user may interact with lock elements 610a and 610b that in turn directly interact with the locking interface of lock mechanism 600. Embodiments of a lock mechanism may additionally or alternatively provide for user operation which indirectly interacts with the locking interface.

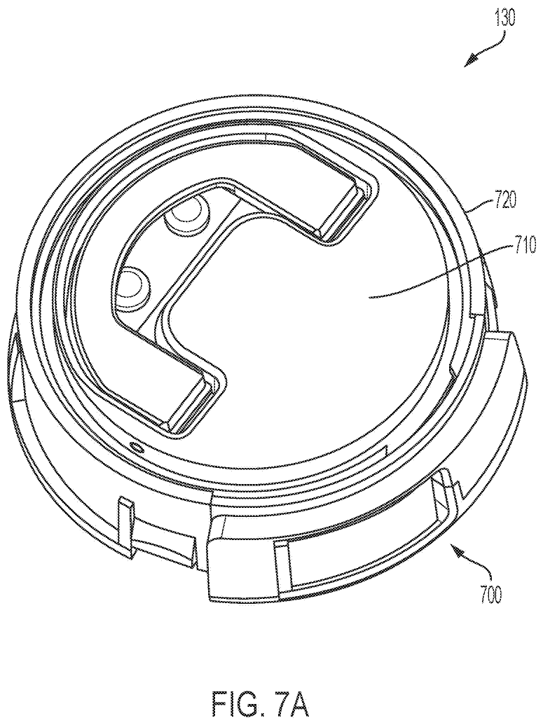

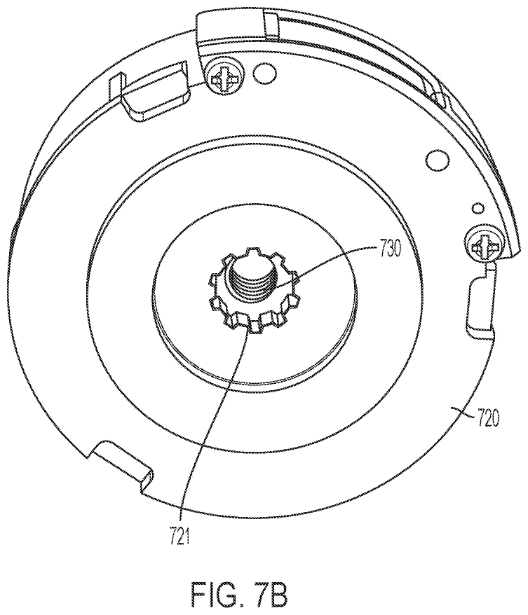

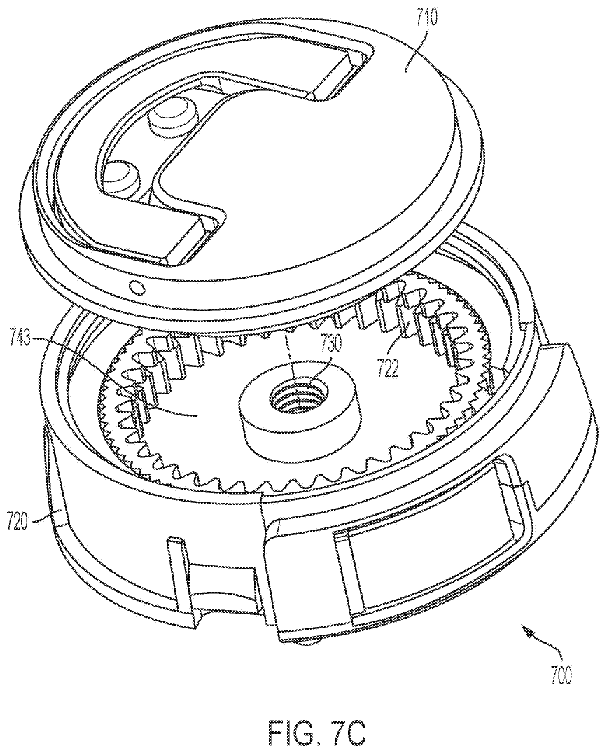

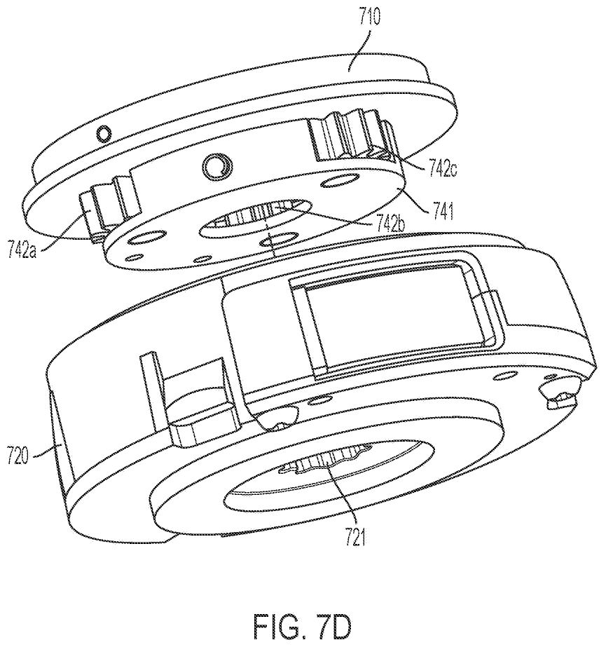

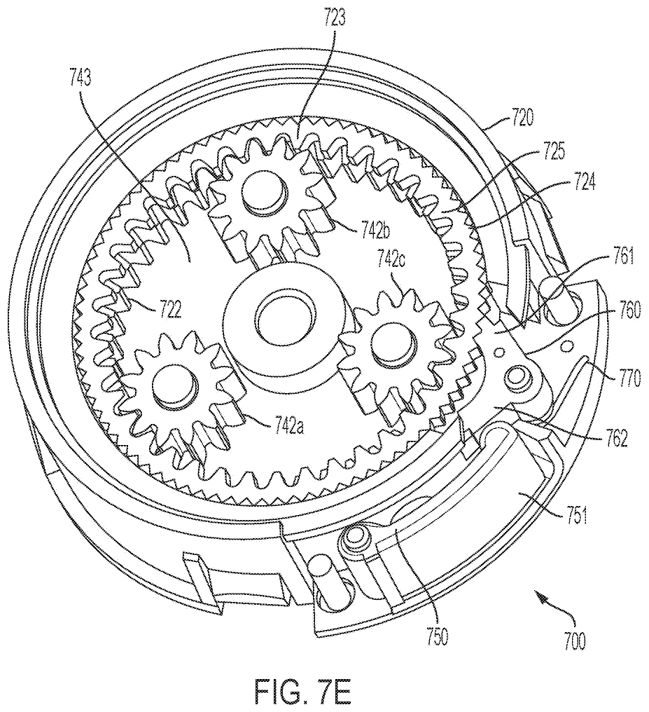

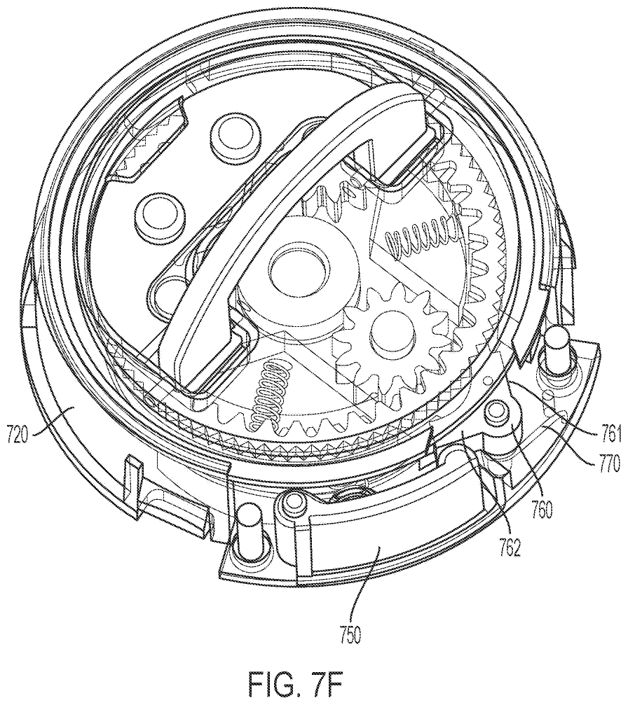

FIGS. 7A-7F show details with respect to an embodiment of force amplified fastener assembly 130 implementing a planetary gear configuration (e.g., similar to that of the planetary gear configuration of FIGS. 2A-2E described above) for giving a mechanical advantage with respect to manual manipulation of the fastener assembly in which indirect interaction with a locking interface is provided. In particular, force amplified fastener assembly 130 of the embodiment of FIGS. 7A-7F provides a button portion comprising a member separate from a lock pawl of a lock mechanism for receiving the user action (e.g., squeezing) to indirectly induce unlocking movement by engage a lever arm of a lock pawl, as described in further detail below.

FIGS. 7A and 7B show a planetary gear configuration of an embodiment of force amplified fastener assembly 130 in its assembled state. As shown in the top isometric view of FIG. 7A, the illustrated planetary gear configuration comprises top housing 710 and bottom structure 720. It should be appreciated that, although the views, housings, and structures are referred to as top and bottom, the designations are relative and there is no limitation that the example force amplified fastener assembly be disposed or utilized in any particular orientation with respect to top and bottom. For example, when utilized with respect to a lawn mower implementation of power tool 100, top housing 710 may be oriented as facing down when installed on shaft 111 and affixing detachable implement 120 in the form of a grass cutting blade to power tool 100.

Top housing 710 and bottom structure 720 are configured for cooperatively incarcerating a planetary gear train and fastening element of the example force amplified fastener assembly. For example, as may be seen in the partially exploded views of FIGS. 7C and 7D, bottom structure 720 may form a cupped structure sized and shaped to accept the circumference of top housing 710. In accordance with some examples, a circumferential edge of top housing 710 may, when fully nested with bottom structure 720, terminate at or very near a top inside circumference of bottom structure 720, such as for incarcerating components of the planetary gear train and for providing a substantially enclosed area in which infiltration of debris and/or other matter is discouraged. The nested relationship of top housing 710 and bottom structure 720 of embodiments, however, allows for relative rotational movement between the top housing and bottom structure (e.g., top housing 710 may be rotated while bottom structure 720 is held stationary).

Bottom structure 720 of the illustrated embodiment is configured to accept insertion of drive member of a power tool, such as shaft 111 of power tool 100, for facilitating interfacing the drive member with a fastening element of force amplified fastener assembly 130. For example, shaft orifice 721 of the illustrated embodiment of bottom structure 720 may be sized and shaped to accommodate insertion of an end of shaft 111 there through. According to some examples, shaft orifice 721 may be shaped or otherwise be configured (e.g., comprising the undulated circumference of the illustrated embodiment, a square circumference, a hexagonal circumference, etc.) for interfacing with one or more components external to force amplifying fastener assembly 130 (e.g., stay 121 of FIG. 1, as may be disposed upon shaft 111), such as for discouraging or preventing relative rotary movement (e.g., for avoiding unintended unfastening the fastening element as a result of inertial force when the power tool stops or is braked).

Force amplified fastener assembly 130 of the embodiment of FIGS. 7A-7F implements a planetary gear train configured for giving a mechanical advantage with respect to applying tightening or loosening torque to fastening element 730 in response to manual manipulation (e.g., grasping by hand to manually apply torque in a fastening direction or releasing direction) of the fastener assembly. Accordingly, as shown in FIGS. 7C and 7D, top housing 710 of the example embodiment includes gear plate 741 housing planet gears 742a-742c which interface with ring gear 722 housed within bottom structure 720 to provide a planetary gearing implementation of force amplified fastener assembly 130. Ring gear 722 is affixed to or formed as part of gear plate 743, nested within bottom structure 720, having fastening element 730 affixed thereto or formed as part thereof. Accordingly, when ring gear 722 rotates, gear plate 743 and fastening element 730 of embodiments will correspondingly be rotated. When top housing 710 is rotated (e.g., in response to a user manually applying a torque force thereto) relative to bottom structure 720, gear plate 741 of embodiments will correspondingly be rotated to cause rotation of ring gear 722 through operation of the planetary gear train, and thus gear plate 743 and fastening element 730 will be rotated in a corresponding direction, albeit at a slower rotational rate having increased torque.

Fastening element 730 of embodiments may comprise a threaded fastening device configured to be rotated in a fastening direction and a releasing direction upon a drive member. For example, the illustrated embodiment of fastening element 730 is appropriately threaded to engage an end of shaft 111 of power tool 100, such as may be utilized to fix, mount, tighten, etc. detachable implement 120 onto shaft 111.

Although fastening element 730 of the example illustrated in FIGS. 7A-7F is described as affixed to or formed as part of gear plate 743, it should be appreciated that other configurations of fastening elements may be utilized according to embodiments of the invention. For example, fastening element 730 may comprise a separate component (e.g., nut) disposed within a fastening element housing of gear plate 743 according to some embodiments.

In operation of force amplified fastener assembly 130 of the embodiment of FIGS. 7A-7F, when shaft 111 is inserted through orifice 721 and interfaces with fastener element 730, top housing 710 may be rotated in a fastening direction to correspondingly rotate fastener element 730 relative to shaft 111. The planetary gear train of the force amplified fastener assembly provides a mechanical advantage with respect to applying torque to fastening element 730. The embodiment of force amplified fastener assembly 130 illustrated in FIGS. 7A-7F, however, includes lock mechanism 700 configured to provide locking with respect to movement of top housing 710 relative to gear plate 743 nested within bottom structure 720 of the force amplified fastener assembly. In particular, lock mechanism 700 of the illustrated embodiment is configured to prevent relative movement in a first direction (e.g., releasing direction) when lock element 750 is in a radially outward position while allowing relative movement in a second direction (e.g., fastening direction) when lock element 750 is in a radially outward position.

For example, lock mechanism 700 of the example illustrated in FIGS. 7A-7F includes lock element 750 disposed in a pivotal relationship with bottom structure 720 for engaging arm 762 of lock element 760, which is also disposed in a pivotal relationship with bottom structure 720. Lock element 760 is configured for engaging locking ring 723 (FIG. 7E) and provide locking with respect to movement of top housing 710 relative to gear plate 743 of force amplified fastener assembly 130. For example, lock element 760 of the illustrated embodiment includes teeth of arm 761 configured for interfacing with teeth 724 disposed upon an outer circumference of locking ring 723, wherein locking ring 723 also includes teeth 725 on an inner circumference thereof engaging teeth of planet gears 742a-742c. According to some embodiments, ring gear 722 may include teeth 724 disposed upon an outer circumference thereof for engaging teeth of arm 761 (e.g., to provide a locking configuration of ring gear 722, such as where locking ring 723 is omitted). As can be seen in FIG. 7E, the teeth of arm 761 of the illustrated embodiment are provided in a saw-tooth type configuration, wherein a ramped side of the saw-teeth permits relative movement of top housing 710 with respect to gear plate 743 in a first direction and a bulkhead side prevents relative movement of top housing 710 with respect to gear plate 743 in a second direction. In the illustrated example, movement of top housing 710 relative to gear plate 743 is prevented in the releasing direction but not the fastening direction.

In operation according to embodiments lock element 760 may comprise a pawl pivotally coupled to bottom structure 720, whereby when the lock element is pivoted such that arm 761 moves radially inward and the teeth thereof engage teeth 724 of locking ring 723 and prevent movement of top housing 710 relative to gear plate 743. Arm 761 of lock element 760 may, nevertheless, be pivoted radially outward to a point that the teeth thereof clear teeth 724 of locking ring 723 and movement of top housing 710 relative to gear plate 743 in the releasing direction is permitted. According to embodiments of lock mechanism 700, lock element 760 may be pivoted such that teeth of arm 762 engage teeth 724 of locking ring 723. As can be seen in FIG. 7F, the teeth of arm 762 of the illustrated embodiment are provided in a saw-tooth type configuration, wherein a ramped side of the saw-teeth permits relative movement of top housing 710 with respect to gear plate 743 in a second direction and a bulkhead side prevents relative movement of top housing 710 with respect to gear plate 743 in a first direction. In the illustrated example, movement of top housing 710 relative to gear plate 743 is prevented in the fastening direction but not the releasing direction.

Lock elements 750 and 760 of embodiments of lock mechanism 700 may utilize user action to unlock and/or lock the lock mechanism. Spring 770 (e.g., a torsion spring and/or other source of bias force) of some embodiments may provide a bias force to hold arm 761 of lock element 760 in a radially inward position (e.g., lock mechanism 700 in a locked state), and correspondingly arm 762 of lock element 760 in a radially outward position. Arm 762 of the illustrated embodiment may engage arm 751 of lock element 750, and thereby encourage arm 751 to a radially outward position (e.g., under force applied by spring 770). In addition to or in the alternative to spring 770 indirectly providing force for encouraging arm 751 to a radially outward position, a torsion spring and/or other source of bias force may be provided with respect to arm 751 to directly encourage arm 751 to a radially outward position.

A user may apply force (e.g., squeezing force) to a button portion of arm 751 (e.g., surface area of the distal end of arm 751) of lock element 750 to cause lock element 760 to pivot between locked and unlocked positions (e.g., lock mechanism in an unlocked state) to disengage the lock mechanism (FIG. 7F). Arm 751 may, for example, be configured to provide a relatively large surface area of a button portion thereof for squeezing by the user (e.g., for facilitating user interfacing, such as with gloved hands). According to some examples, a button portion of arm 751 may be adapted to facilitate a user interfacing with the lock mechanism for facilitating gripping and application of force (e.g., provided with markings to indicate an area to apply squeezing pressure, surface perturbations, rubberized over-molding, etc., to accommodate application of squeezing force without slipping, etc.). In unlocking operation, arm 751 of lock element 750 may engage arm 762 of lock element 760, overcome the bias force of spring 770, to thereby encourage arm 762 to a radially inward position, and correspondingly cause arm 761 of lock element 760 in a radially outward position. As shown in FIG. 7F, wherein the surface of top housing is shown as transparent, the teeth of arm 761 may thus disengage teeth 724 of locking ring 723. Accordingly, lock mechanism 700 may be placed in an unlocked state and the user may be enabled to move (e.g., rotate in an unfastening direction) top housing 710 relative to gear plate 743 (e.g., to provide force amplified rotation of fastener element 730 relative to shaft 111).

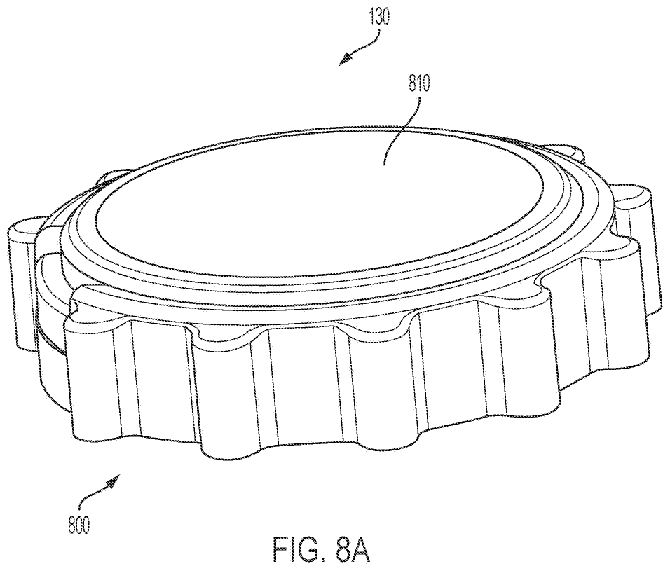

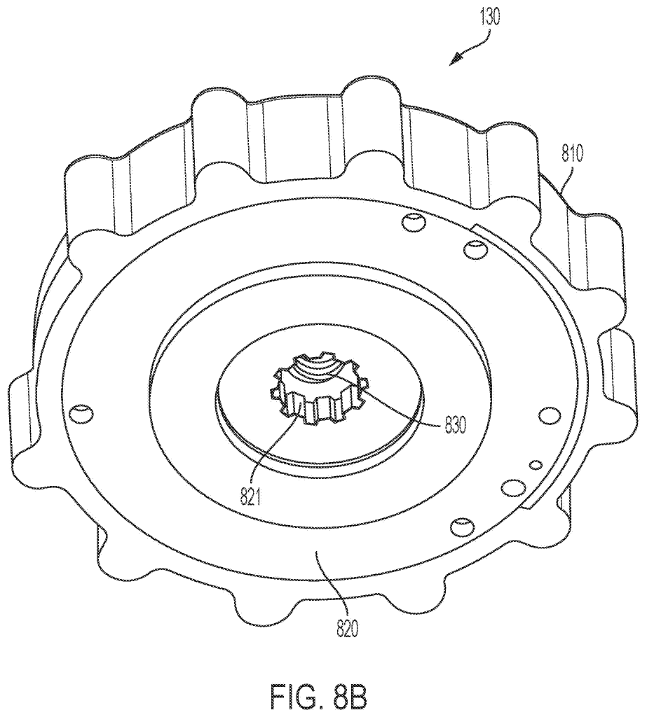

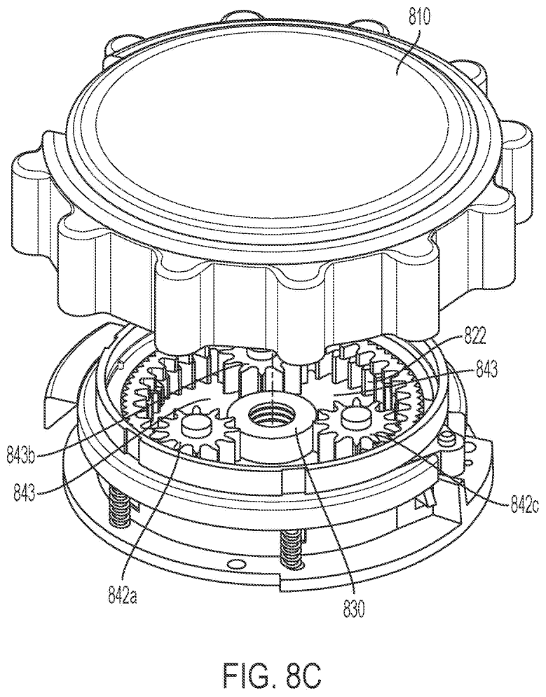

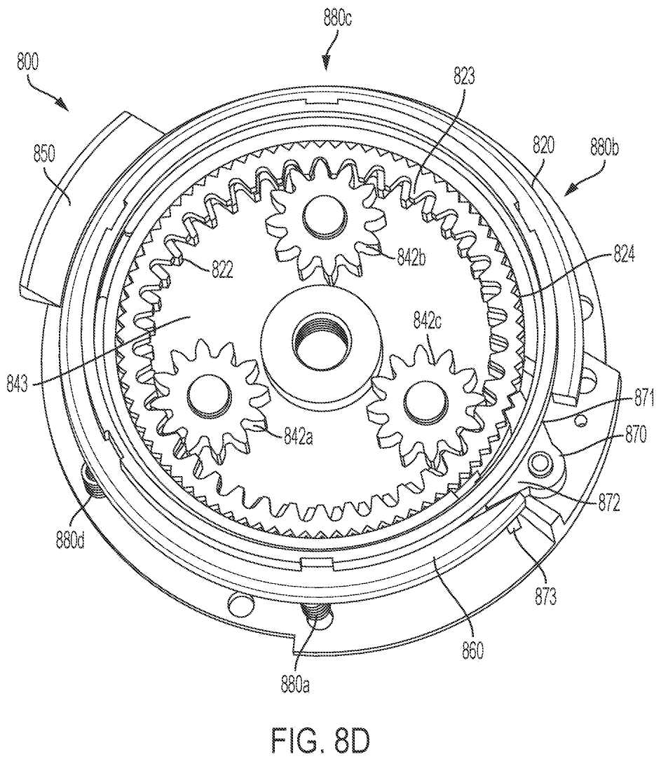

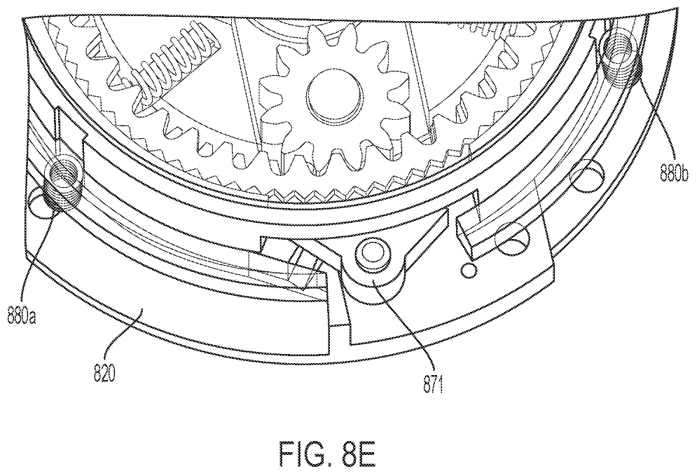

FIGS. 8A-8E show details with respect to another embodiment of force amplified fastener assembly 130 implementing a planetary gear configuration (e.g., similar to that of the planetary gear configuration of FIGS. 2A-2E described above) for giving a mechanical advantage with respect to manual manipulation of the fastener assembly in which indirect interaction with a locking interface is provided. In particular, force amplified fastener assembly 130 of the embodiment of FIGS. 8A-8E provides a button portion comprising a member separate from a lock pawl of a lock mechanism for receiving the user action (e.g., depressing) to indirectly induce unlocking movement by engage a lever arm of a lock pawl, as described in further detail below.

FIGS. 8A and 8B show a planetary gear configuration of an embodiment of force amplified fastener assembly 130 in its assembled state. As shown in the top isometric view of FIG. 8A, the illustrated planetary gear configuration comprises top housing 810. Correspondingly, as shown in the bottom isometric view of FIG. 8B, the illustrated planetary gear configuration comprises bottom structure 820. It should be appreciated that, although the views, housings, and structures are referred to as top and bottom, the designations are relative and there is no limitation that the example force amplified fastener assembly be disposed or utilized in any particular orientation with respect to top and bottom. For example, when utilized with respect to a lawn mower implementation of power tool 100, top housing 810 may be oriented as facing down when installed on shaft 111 and affixing detachable implement 120 in the form of a grass cutting blade to power tool 100.

Top housing 810 and bottom structure 820 are configured for cooperatively incarcerating a planetary gear train and fastening element of the example force amplified fastener assembly. For example, as may be seen in the partially exploded view of FIG. 8C, bottom structure 820 may form a cupped structure sized and shaped to nest within a cupped casing formed by top housing 810. In accordance with some examples, the top edge circumference of bottom structure 820 may, when fully nested with top housing 810, terminate at or very near the bottom facing surface of top housing 810, such as for incarcerating components of the planetary gear train and for providing a substantially enclosed area in which infiltration of debris and/or other matter is discouraged. The nested relationship of top housing 810 and bottom structure 820 of embodiments, however, allows for relative rotational movement between the top housing and bottom structure (e.g., top housing 810 may be rotated while bottom structure 820 nested therein is held stationary).

Bottom structure 820 of the illustrated embodiment is configured to accept insertion of drive member of a power tool, such as shaft 111 of power tool 100, for facilitating interfacing the drive member with a fastening element of force amplified fastener assembly 130. For example, shaft orifice 821 of the illustrated embodiment of bottom structure 820 may be sized and shaped to accommodate insertion of an end of shaft 111 there through. According to some examples, shaft orifice 821 may be shaped or otherwise be configured (e.g., comprising the undulated circumference of the illustrated embodiment, a square circumference, a hexagonal circumference, etc.) for interfacing with one or more components external to force amplifying fastener assembly 130 (e.g., stay 121 of FIG. 1, as may be disposed upon shaft 111), such as for discouraging or preventing relative rotary movement (e.g., for avoiding unintended unfastening the fastening element as a result of inertial force when the power tool stops or is braked).

Force amplified fastener assembly 130 of the embodiment of FIGS. 8A-8E implements a planetary gear train configured for giving a mechanical advantage with respect to applying tightening or loosening torque to fastening element 830 in response to manual manipulation (e.g., grasping by hand to manually apply torque in a fastening direction or releasing direction) of the fastener assembly. Accordingly, as shown in FIGS. 8C and 8D, bottom structure 820 of the example embodiment includes gear plate 843 housing planet gears 842a-842c which interface with ring gear 822 affixed to or formed as part of bottom structure 820. Gear plate 843 having ring gear 822 and planet gears 842a-842c are housed within bottom structure 820 to provide a planetary gearing implementation of force amplified fastener assembly 130. Gear plate 843, nested within bottom structure 820 according to embodiments, has fastening element 830 affixed thereto or formed as part thereof. Accordingly, when ring gear 822 rotates, gear plate 843 and fastening element 830 of embodiments will correspondingly be rotated. When top housing 810 is rotated (e.g., in response to a user manually applying a torque force thereto) relative to bottom structure 820, gear plate 843 and fastening element 830 of embodiments will correspondingly be rotated through operation of the planetary gear train, albeit at a slower rotational rate having increased torque.

Fastening element 830 of embodiments may comprise a threaded fastening device configured to be rotated in a fastening direction and a releasing direction upon a drive member. For example, the illustrated embodiment of fastening element 830 is appropriately threaded to engage an end of shaft 111 of power tool 100, such as may be utilized to fix, mount, tighten, etc. detachable implement 120 onto shaft 111.

Although fastening element 830 of the example illustrated in FIGS. 8A-8E is described as affixed to or formed as part of gear plate 843, it should be appreciated that other configurations of fastening elements may be utilized according to embodiments of the invention. For example, fastening element 830 may comprise a separate component (e.g., nut) disposed within a fastening element housing of gear plate 843 according to some embodiments.

In operation of force amplified fastener assembly 130 of the embodiment of FIGS. 8A-8E, when shaft 111 is inserted through orifice 821 and interfaces with fastener element 830, top housing 810 may be rotated in a fastening direction to correspondingly rotate fastener element 830 relative to shaft 111. The planetary gear train of the force amplified fastener assembly provides a mechanical advantage with respect to applying torque to fastening element 830. The embodiment of force amplified fastener assembly 130 illustrated in FIGS. 8A-8E, however, includes lock mechanism 800 configured to provide locking with respect to movement of top housing 810 relative to gear plate 843 nested within bottom structure 820 of the force amplified fastener assembly. In particular, lock mechanism 800 of the illustrated embodiment is configured to prevent relative movement in a first direction (e.g., releasing direction) when lock element 850 is in a up position while allowing relative movement in a second direction (e.g., fastening direction) when lock element 850 is in a down position.

For example, lock mechanism 800 of the example illustrated in FIGS. 8A-8E includes lock element 850 disposed in a linear traversal relationship with bottom structure 820 for engaging lock element 860, which is also disposed in a linear traversal relationship with bottom structure 820. According to the example of FIGS. 8A-8E, the linear traversal relationship of lock elements 860 and 860 provides for their movement orthogonally (e.g., up and down) with respect to a gear plane of bottom structure 820. Lock element 860, comprising a ring or ring portion at least partially encircling ring gear 822 of bottom structure 820 according to the illustrated embodiment, is configured for engaging lock element 870, which is disposed in a pivotal relationship with bottom structure 820. Lock element 870 includes arm 872 having ramp portion 873 thereof (FIG. 8D) configured for interfacing with lock element 860. Lock element 870 is further configured for engaging locking ring 823 and provide locking with respect to movement of top housing 810 relative to gear plate 843 of force amplified fastener assembly 130. For example, lock element 870 of the illustrated embodiment includes teeth of arm 871 configured for interfacing with teeth 824 disposed upon an outer circumference of locking ring 823, wherein locking ring 823 also includes teeth 825 on an inner circumference thereof engaging teeth of planet gears 842a-842c. According to some embodiments, ring gear 822 may include teeth 824 disposed upon an outer circumference thereof for engaging teeth of arm 871 (e.g., to provide a locking configuration of ring gear 822, such as where locking ring 823 is omitted). As can be seen in FIG. 8D, the teeth of arm 871 of the illustrated embodiment are provided in a saw-tooth type configuration, wherein a ramped side of the saw-teeth permits relative movement of top housing 810 with respect to gear plate 843 in a first direction and a bulkhead side prevents relative movement of top housing 810 with respect to gear plate 843 in a second direction. In the illustrated example, movement of top housing 810 relative to gear plate 843 is prevented in the releasing direction but not the fastening direction.

In operation according to embodiments lock element 870 may comprise a pawl pivotally coupled to bottom structure 820, whereby when the lock element is pivoted such that arm 871 moves radially inward and the teeth thereof engage teeth 824 of locking ring 823 and prevent movement of top housing 810 relative to gear plate 843. Arm 871 of lock element 870 may, nevertheless, be pivoted radially outward to a point that the teeth thereof clear teeth 824 of locking ring 823 and movement of top housing 810 relative to gear plate 843 in the releasing direction is permitted. According to embodiments of lock mechanism 800, lock element 870 may be pivoted such that teeth of arm 872 engage teeth 824 of locking ring 823. As can be seen in FIG. 8E, the teeth of arm 872 of the illustrated embodiment are provided in a saw-tooth type configuration, wherein a ramped side of the saw-teeth permits relative movement of top housing 810 with respect to gear plate 843 in a second direction and a bulkhead side prevents relative movement of top housing 810 with respect to gear plate 843 in a first direction. In the illustrated example, movement of top housing 810 relative to gear plate 843 is prevented in the fastening direction but not the releasing direction.

Lock elements 850, 860, and 870 of embodiments of lock mechanism 800 may utilize user action to unlock and/or lock the lock mechanism. Springs 880a-880d (e.g., compression springs and/or other source of bias force) of some embodiments may provide a bias force to hold lock element 860 in an upward position such that ramp portion 873 allows arm 872 of lock element 870 to be disposed in a radially outward position, and correspondingly arm 871 of lock element 870 in a radially inward position (e.g., lock mechanism 800 in a locked state). A torsion spring (e.g., similar to spring 770 of FIGS. 7E and 7F) and/or other source of bias force may be utilized to provide a bias force to hold arm 871 of lock element 870 in a radially inward position when lock element 860 is disposed in an upward position according to embodiments. Further, a bias force holding lock element 860 in an upward position according to embodiments may correspondingly hold lock element 850 in an upward (e.g., un-depressed) position. For example, a portion of lock element 860 of the illustrated embodiment may engage a bottom portion of lock element 850, and thereby encourage lock element 850 to an upward position (e.g., under force applied by springs 880a-880d). In addition to or in the alternative to springs 880a-880d indirectly providing force for encouraging lock element 850 to an upward position, a compression spring and/or other source of bias force may be provided with respect to lock element 850 to directly encourage lock element 850 to an upward position.

A user may apply force (e.g., depressing force) to a button portion of lock element 850 (e.g., surface area of the top of lock element 850) to cause lock elements 850 and 860 to move downward and cause lock element 870 to pivot between locked and unlocked positions (e.g., lock mechanism in an unlocked state) to disengage the lock mechanism (FIG. 8E). Lock element 850 may, for example, be configured to provide a relatively large surface area of a button portion thereof for depressing by the user (e.g., for facilitating user interfacing, such as with gloved hands). According to some examples, a button portion of a top surface of lock element 850 may be adapted to facilitate a user interfacing with the lock mechanism for facilitating gripping and application of force (e.g., provided with markings to indicate an area to apply squeezing pressure, surface perturbations, rubberized over-molding, etc., to accommodate application of squeezing force without slipping, etc.). In unlocking operation, a bottom surface of lock element 850 may engage lock element 860, overcome the bias force of springs 880a-880d, to thereby encourage lock element 860 to a downward position. In turn, lock element 860 may engage ramp portion 873 of arm 872 and encourage arm 872 to a radially inward position, and correspondingly cause arm 871 of lock element 870 in a radially outward position. As shown in FIG. 8E, wherein the surface of top housing is shown as transparent, the teeth of arm 871 may thus disengage teeth 824 of locking ring 823. Accordingly, lock mechanism 800 may be placed in an unlocked state and the user may be enabled to move (e.g., rotate in an unfastening direction) top housing 810 relative to gear plate 843 (e.g., to provide force amplified rotation of fastener element 830 relative to shaft 111).

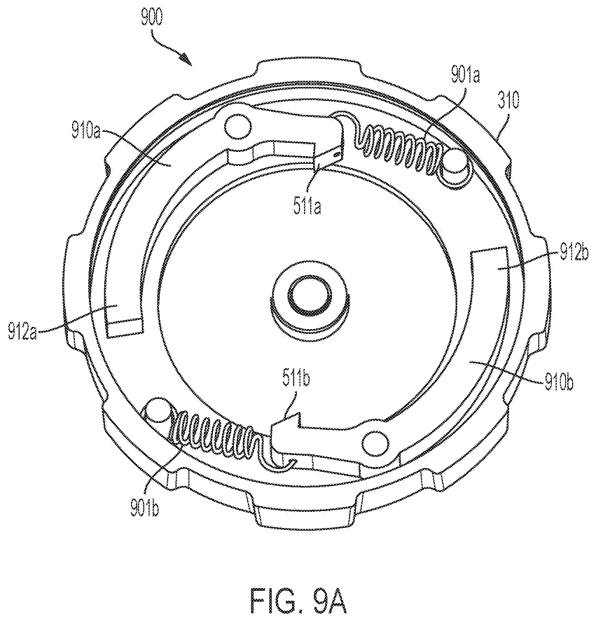

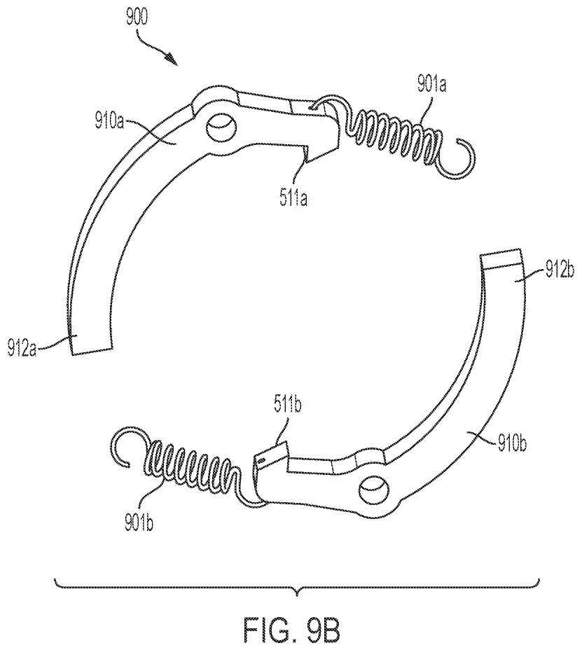

FIGS. 9A and 9B show details with respect to another exemplary lock mechanism as may be implemented with respect to the cycloid gear train configuration of the embodiment of FIGS. 3A-3E. Lock mechanism 900 of the example illustrated in FIGS. 9A and 9B includes lock elements 910a and 910b disposed in the underside of top housing 310. Lock elements 910a and 910b are configured for engaging bottom structure 320 (FIG. 3D) and provide locking with respect to movement of top housing 310 relative to bottom structure 320 of force amplified fastener assembly 130. For example, lock elements 910a and 910b of the illustrated embodiment include teeth 911a and 911b, respectively, configured for interfacing with teeth 323 (FIG. 3D) disposed upon an outer circumference of ring gear 322 of bottom structure 220. Lock elements 910a and 910b may, for example, comprise pawls pivotally coupled to the underside surface of top housing 310, whereby when the lock elements are pivoted such that teeth 911a and 911b move radially inward such that the teeth engage teeth 323 of ring gear 322 and prevent movement of top housing 310 relative to bottom structure 320. Further, lock elements 910a and 910b may be pivoted radially outward to a point that teeth 911a and 911b clear teeth 323 of ring gear 322 and movement of top housing 310 relative to bottom structure 320 is permitted.

Lock elements 910a and 910b of embodiments of lock mechanism 900 may pivoted between locked and unlocked positions in response to various forces, such as centrifugal force and/or the force of gravity. For example, lock mechanism 900 may be placed in a locked state to prevent rotation in the releasing direction while the detachable implement is spinning sufficiently rapidly to cause lock elements 910a and 910b to pivot and cause teeth 911a and 911b to engage teeth 323. In accordance with the illustrated example, weighted arms 912a and 912b of lock elements 910a and 910b, respectively, may cause the lock elements to pivot such that teeth 911a and 911b move inward and engage teeth 323 in response to centrifugal force resulting from rotation of the detachable implement and corresponding force amplified fastener assembly at a sufficient speed. In accordance with this example, when power tool 100 is stopped, springs 901a and 901b may provide bias forces to pull lock elements 910a and 910b such that they are pivoted sufficiently for teeth 911a and 911b to disengage teeth 323. Additionally or alternatively, lock mechanism 900 may be placed in an unlocked state by the force of gravity to allow rotation in the releasing direction when power tool 100 is disposed in a particular orientation (e.g., unlocked when a head of the power tool upon which a detachable implement is fastened is turned upside down for user service). According to some embodiments, lock mechanism 900 may additionally or alternatively utilize user action to unlock and/or lock the lock mechanism. Springs 901a and 901b may, for example, be disposed to provide a bias force to hold lock elements 910a and 910b, respectively, such that teeth 911a and 911b are disposed in a radially inward position (e.g., lock mechanism 900 in a locked state). A user may apply a force (e.g., squeezing force) to a portion of lock elements 910a and 910b (e.g., pressing weighted arms 912a and 912b) made accessible via corresponding openings in top housing 310 to cause the lock elements to pivot such that teeth 911a and 911b move radially outward (e.g., lock mechanism 900 in an unlocked state) to disengage the lock mechanism.

In operation according to the illustrated embodiment of lock mechanism 900, movement of top housing 310 relative to bottom structure 320 when lock mechanism 900 is in a locked state is prevented in the releasing direction while movement in the fastening direction is permitted. For example, teeth 911a and 911b and teeth 323 of the illustrated embodiment are provided in saw-tooth type configurations, wherein a ramped side of the saw-teeth permits relative movement and a bulkhead side prevents relative movement such that movement of top housing 310 relative to bottom structure 320 is prevented in one direction (e.g., the releasing direction) but not the other (e.g., the fastening direction). Alternative embodiments of lock mechanism 900 may be configured to prevent movement of top housing 310 relative to bottom structure 320 in both the fastening direction and releasing direction when lock mechanism 900 is in a locked state. For example, teeth 911a and 911b and teeth 323 may be correspondingly sized and shaped to provide a locking engagement (e.g., when lock elements 910a and 910b are pivoted such that teeth 911a and 911b engage teeth 323) which discourages rotation in either direction.

It should be appreciated that the foregoing lock mechanisms are substantially protected by structure of force amplified fastener assembly 130. For example, lock mechanisms 400, 500, 600, 700, 800, and 900 of the illustrated embodiments are disposed within an area of the cupped casing formed by the top housing and/or bottom structure. Moreover, embodiments of the lock mechanisms may be fully encased by the top housing and bottom structure (e.g., as provided by top housing 210 and bottom structure 220 with respect to the example of lock mechanisms 500 and as provided by top housing 310, bottom structure 320, and bottom housing 301 with respect to the example of lock mechanism 900), thereby providing added protection of the lock mechanisms. Accordingly, the lock mechanisms of embodiments of the invention may be protected from damage and unintentional release, such as may otherwise result in damage causing unintentional release of the latch mechanism and allowing the fastening device to become detached from the lawn mower.

As discussed with respect to the exemplary embodiments of force amplified fastener assemblies above, manual manipulation of the fastener assembly (e.g., grasping by hand to manually apply torque in a fastening direction or releasing direction) may be utilized in supplying a tightening or loosening torque through a gear train configured for giving a mechanical advantage with respect to applying torque to a fastening element of the force amplified fastener assembly. Accordingly, force amplified fastener assemblies of embodiments of the invention may include one or more features for facilitating a user grasping and manually apply tightening or loosening torque. For example, a top housing and/or other structure of a force amplified fastener assembly of embodiments may be configured to include one or more features to facilitate manual manipulation by a user.

According to examples described above, a top housing of a force amplified fastener assembly may be sized and shaped to facilitate grasping by hand so that a user may manually apply torque forces. Surface features (e.g., rib structures, surface perturbations, rubberized over-molding, etc.) may additionally or alternatively be provided for facilitating gripping and application of force. According to some examples of a force amplified fastener, further and/or alternative structures may be provided for facilitating the application of torque by a user.

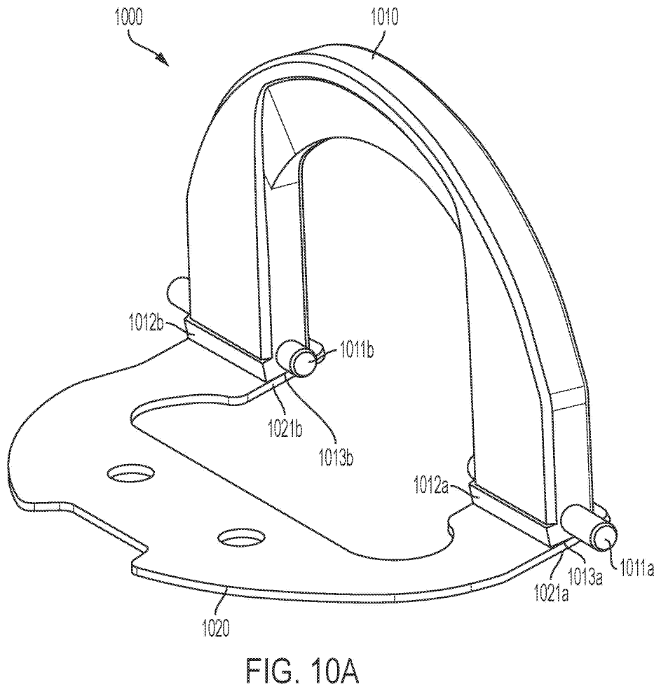

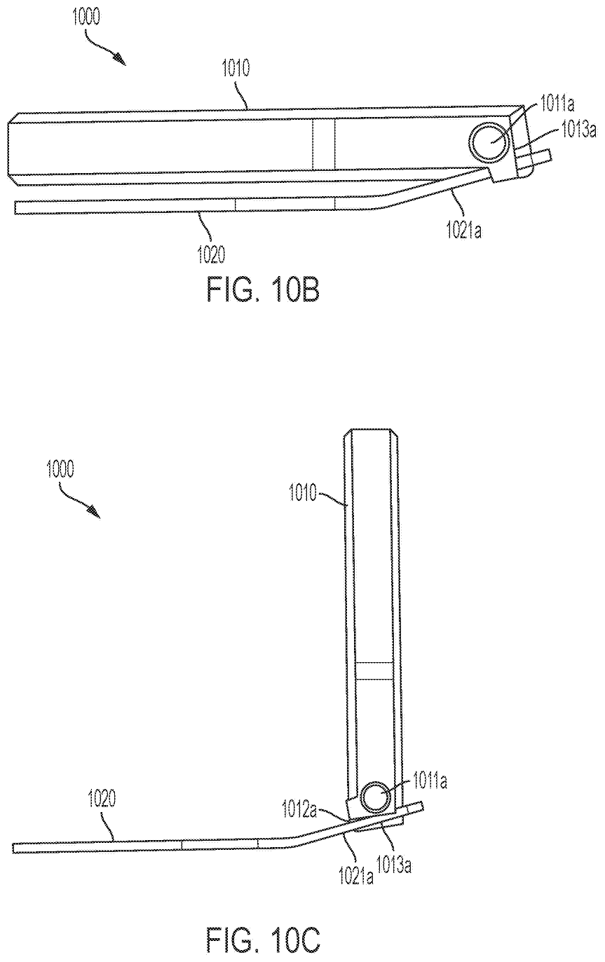

In accordance with embodiments of the invention, structure provided for facilitating the application of torque by a user may comprise one or more grasping members. FIGS. 10A-10C show detail with respect to a grasping member in the form of flip handle assembly 1000 provided for facilitating the application of torque by a user. The embodiment of force amplified fastener assembly 130 of FIGS. 7A-7F shows an example implementation of flip handle assembly 1000 in accordance with concepts herein.

Flip handle assembly 1000 of the illustrated embodiment provides a retractable handle (e.g., flip-up/flip-down handle disposable in a storage position and a use position) to facilitate a user grasping and manually applying tightening or loosening torque with respect to a force amplified fastener assembly. For example, as shown in FIGS. 10A-10C, flip handle assembly 1000 of embodiments includes handle 1010 hingedly disposed with respect to plate 1020 such that handle 1010 may be disposed in a use position (as shown in FIGS. 10A and 10C) and a storage position (as shown in FIG. 10B). For example, handle 1010 may be mounted using pins 1011a and 1011b disposed through ends of the handle proximal to plate 1020. Pins 1011a and 1011b may, for example, interface with hinge pin knuckles disposed on plate 1020 (e.g., plate 1020 of some embodiments may provide a mounting plate for fastening flip handle assembly 1000 to a force amplified fastener assembly). In accordance with the example of force amplified fastener assembly 130 in FIGS. 7A, 7C, and 7F, pins 1011a and 1011b interface with hinge pin vias of top housing 710 (e.g., plate 1020 of this embodiment may provide a spring plate for encouraging handle 1010 to remain in the use position and/or the storage position). Irrespective of the particular mounting configuration of pins 1011a and 1011b, pivoting of handle 1010 about the axis of pins 1011a and 1011b is provided according to embodiments of flip handle assembly 1000.

Flip handle assembly 1000 may be disposed upon a face of a component of a force amplified fastener assembly which is to have torque applied thereto. As shown in the example embodiment of force amplified fastener assembly 130 in FIGS. 7A, 7C, and 7F, flip handle assembly 1000 may be disposed upon an upper face of top housing 710 in a gear plane or other fastening/releasing rotation plane of the force amplified fastener assembly. Plate 1020 may, for example, be fastened to the upper face of top housing 710 using one or more fastening means (e.g., adhesive, screws, brads, rivets, bolts, locking tabs, etc.). Handle 1010 of flip handle assembly 1000 may be disposed in a use position (e.g., as shown in FIGS. 7F, 10A, and 10C) to facilitate a user's grip and application of force with respect to the component. A user may thus readily grasp handle 1010 by hand to manually apply tightening or loosening torque with respect to top housing 710, thereby operating the force amplified fastener assembly for tightening or loosening fastening element 730. Handle 1010 of flip handle assembly 1000 may be disposed in a storage position (e.g., as shown in FIGS. 7A, 7C, and 10B) to enable use of a host power tool to which a force amplified fastener assembly is attached to be used without interference from, and/or causing damage to, the handle.

Handle 1010 of embodiments may be configured to facilitate grasping by a user. The illustrated embodiment of handle 1010 comprises a “U” shaped configuration providing both appreciable surface area for the application of force by the user and a void for accommodating the passage of a thumb and/or one or more fingers therethrough to facilitate non-slip gripping of the handle. It should be appreciated, however, that other shapes of handles (e.g., “T” shaped, hook shaped, etc. configurations) may be utilized according to concepts herein. Features in addition to or in the alternative to the shape of the handle may be utilized to facilitate grasping by a user. For example, embodiments of handle 1010 may comprise surface features (e.g., surface perturbations, rubberized over-molding, finger grips, etc.) for facilitating gripping and application of force.

Embodiments of flip handle assembly 1000 and/or force amplified fastener assembly 130 are configured so that that handle 1010 may be stored such that it is not damaged during use or impedes use of a host power tool. For example, a component of a force amplified fastener assembly upon which flip handle assembly 1000 is disposed may be configured to provide some aspect of protection with respect to handle 1010 when disposed in a storage position. As shown in the example of FIGS. 7A, 7C, and 7F, top housing 710 provides a recess into which handle 1010 may be nested when disposed in the storage position, whereby top housing 710 provides structure to protect the handle during use of a host power tool to which a force amplified fastener assembly is attached. Additionally or alternatively, handle 1010 and plate 1020 of embodiments are configured to encourage handle 1010 to remain in a storage position for avoiding the handle interfering with operation of a host power tool and/or avoiding damage to the handle. For example, as may be seen in FIGS. 10A-10C, plate 1020 of the illustrated embodiment includes flat spring portions 1021a and 1021b are configured to interface with end portions of handle 1010 proximal to plate 1020. Lower face surfaces 1012a and 1021b of embodiments may, for example be configured to accommodate handle 1010 resting in a storage position, whereas butt surfaces 1013a and 1013b may be configured to accommodate handle 1010 resting in a use position. In operation according to embodiments, the transition feature between the lower face and butt surfaces (e.g., the apex between lower face surface 1012a and butt surface 1013a and the apex between lower face surface 1012b and butt surface 1013b) engages a respective flat spring (e.g., flat spring portion 1021a and 1021b, respectively) when handle 1010 is rotated out of the use position or storage position. The engagement of these transition features results in a bias, or increase bias, being applied to handle 1010 and encourages the handle to either remain in its current position (e.g., either the use position or the storage position) or fully transition to the other position (e.g., the storage position or the use position). Accordingly, once placed in the storage position, handle 1010 of embodiments is encouraged to remain in that position until deliberately moved from that position by a user. Similarly, once placed in the use position, handle 1010 of embodiments is encouraged to remain in that position until deliberately moved from that position by the user.

Force amplified fastener assemblies of embodiments may be utilized in harsh environments and/or other conditions which may cause wear and/or damage to the force amplified fastener assembly and/or its components. For example, some examples of force amplified fastener assembly 130 may be utilized with respect to a host power tool, such as a brush cutter, string trimmer, lawn mower, etc., and be subjected to abrasive wear (e.g., due to contact with rocks, concrete, sand, etc.) and/or infiltration by various materials (e.g., soil, mud, sand, etc.). Accordingly, embodiments of a force amplified fastener assembly may include one or more removable/replaceable exterior surface coverings, such as may present a protective surface for some portion of the force amplified fastener assembly. Such removable/replaceable exterior surface coverings may, for example, be utilized to maximize the life cycle of a force amplified fastener assembly at least in part by providing a protective covering that is readily replaceable by the user.

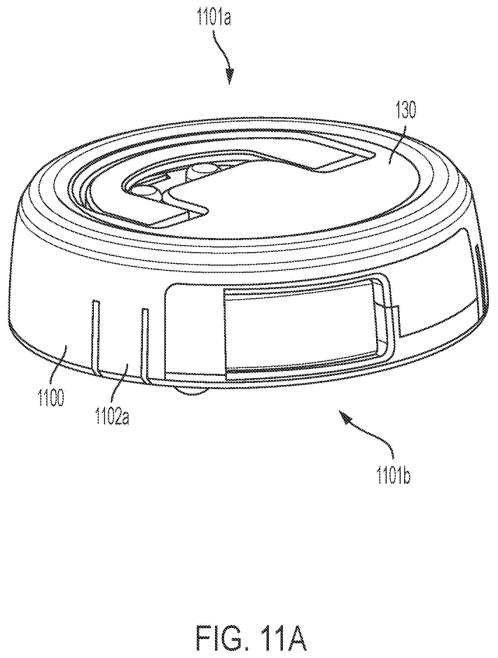

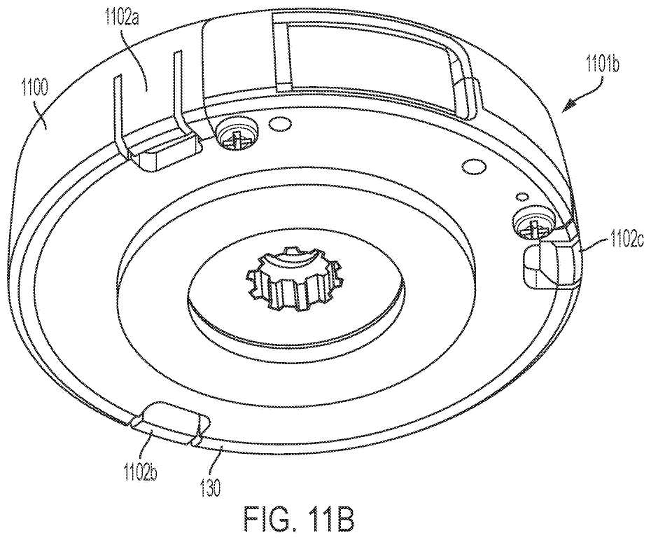

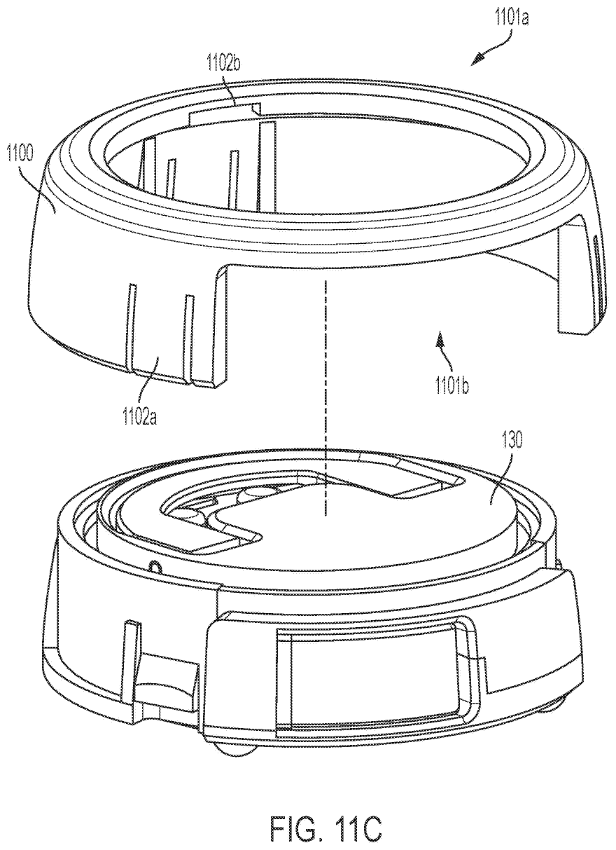

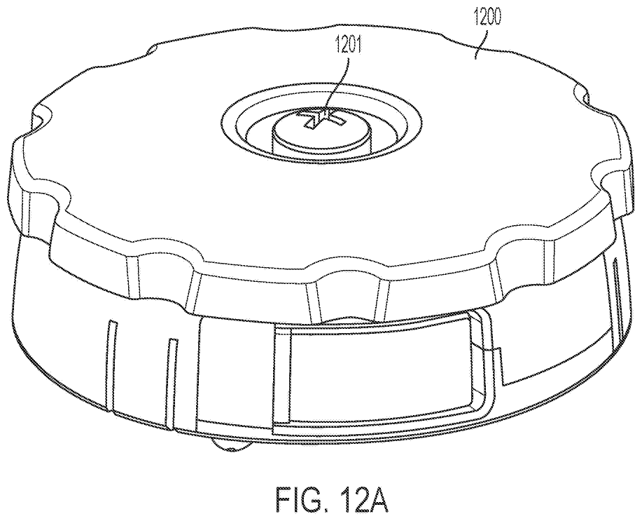

FIGS. 11A-11C, for example, illustrate an example of a removable/replaceable exterior surface covering in the form of a replaceable jacket configured to cover a portion of force amplified fastener assembly 130 according to embodiments of the invention. Replaceable jacket 1100 shown in FIGS. 11A-11C provides covering of at least a portion of the top housing (e.g., the outer circumference of the top surface of the top housing) of force amplified fastener assembly 130. Further, replaceable jacket 1100 of the illustrated embodiment provides covering of at least a portion of the side or circumferential surface (e.g., the cupped sides of the top housing and/or bottom structure) of force amplified fastener assembly 130. Although providing covering of various portions of force amplified fastener assembly 130, replaceable jacket 1100 of embodiments may be configured to facilitate user access to one or more features of the force amplified fastener assembly. For example, grasping member orifice 1101a may be provided for accommodating access to one or more grasping members (e.g., handle 1010 of flip handle assembly 1000 of FIGS. 10A-10C). Additionally or alternatively, lock element orifice 1101b may be provided for accommodating access to one or more lock elements (e.g., lock elements 410a and 410b of lock element 400 of FIGS. 4A and 4B, a button portion of arms 612a and 612b of lock elements 610a and 610b of FIGS. 6A and 6B, lock element 750 of lock mechanism 700 of FIGS. 7A-7F, etc.).

Replaceable jacket 1100 may present one or more protective surfaces (e.g., abrasion restive surface, wear surface, sacrificial surface, etc.) configured to provide protection to one or more surfaces and/or components of a force amplified fastener assembly. For example, replaceable jacket 1100 of embodiments may be comprised of relatively hard materials, such as steel, titanium, and/or composites thereof to provide abrasion restive surfaces which are very slow to wear through and/or otherwise fail to protect surfaces and/or components thereunder in operation of the host power tool abrasive conditions. As another example, replaceable jacket 1100 of embodiments may be comprised less hard materials, such as aluminum, zinc alloys, and/or composites thereof to provide wear surfaces which are somewhat slow to wear through and/or otherwise fail to protect surfaces and/or components thereunder in operation of the host power tool abrasive conditions. In yet another example, replaceable jacket 1100 of embodiments may be comprised of somewhat softer materials, such as plastic, hard rubber, and/or composites thereof to provide sacrificial surfaces to take wear resulting from operation of the host power tool abrasive conditions. It should be appreciated that embodiments of replaceable jacket 1100 may be comprised of more than one material and/or materials having different characteristics. For example, some embodiments of replaceable jacket 1100 may comprise an under layer comprising a somewhat softer material (e.g., plastic or hard rubber) and an outer layer comprising a relatively hard material (e.g., steel or titanium). The under layer of such as configuration may facilitate lower cost of materials, deformation for installing and removing the removable jacket over a force amplified fastener assembly, etc. while the outer layer provides protection to both the under layer and one or more components of the force amplified fastener assembly. Irrespective of the particular material or materials from replaceable jacket 1100 is made, the removable jacket of embodiments provides a replaceable covering to provide protection with respect to one or more aspects of a force amplified fastener assembly.

A surface of replaceable jacket 1100 covering at least some portion of force amplified fastener assembly 130 may stand proud of, or otherwise provide covering to, one or more surfaces and/or components of the force amplified fastener assembly and accept impacts and abrasions during operation of a host power tool to protect and discourage damage to the surfaces, components, and/or other portions of the force amplified fastener assembly. For example, the surface of replaceable jacket 1100 covering the outer circumference of the top housing of the force amplified fastener assembly may provide protection to the top housing, or some portion thereof, and/or components thereon (e.g., a handle of a grasping member). Similarly, the surface of replaceable jacket 1100 covering the circumferential surface of the force amplified fastener assembly may provide protection to the side or circumferential surface, or some portion thereof, and/or components thereon (e.g., a button of a locking member, etc.). Additionally or alternatively, a surface of replaceable jacket 1100 covering at least some portion of force amplified fastener assembly 130 may cover and protect and/or enclose one or more areas (e.g., interfaces between components of the force amplified fastener assembly) of a force amplified fastener assembly to thereby discourage infiltration by foreign material. For example, the surface of replaceable jacket 1100 covering the outer circumference of top housing of force amplified fastener assembly 130 may provide protection to an interface between the top housing and bottom structure (e.g., the interface between top housing 710 and bottom structure 720 of the embodiment of FIGS. 7A-7F) and discourage ingress of material into an interior cavity of the force amplified fastener assembly.

Replaceable jackets of embodiments of the invention may comprise one or more features configured for facilitating their being removably retained in association with components of a force amplified fastener assembly. For example, a replaceable jacket may comprise various attachment points (e.g., vias, channels, slots, pads, etc.) for accepting one or more fasteners (e.g., screws, bolts, brads, rivets, adhesive, etc.) and/or attachment members (e.g., tabs, clips, hasps, clasps, etc.). Additionally or alternatively, replaceable jackets of embodiments of the invention may comprise various forms of attachment members (e.g., tabs, clips, hasps, clasps, etc.) configured to engage a portion of one or more components of a force amplified fastener assembly for releasable attachment thereto. For example, the embodiment of replaceable jacket 1100 shown in FIGS. 11A-11C includes locking tabs 1102a-1102c configured to facilitate components of a force amplified fastener assembly being slid into a cavity of a cupped casing formed by the replaceable jacket, whereby once the components of the force amplified fastener assembly are fully nested with replaceable jacket 1100 the locking tabs engage one or more components of the force amplified fastener assembly and retain the replaceable jacket and other components of the force amplified fastener in the nested relationship. For example, locking tabs 1102a-1102c may provide spring tabs which deform radially outward to allow passage of structure of one or more components (e.g., cupped structure formed by bottom structure 720) into the cavity of the cupped casing formed by the replaceable jacket. Once the structure of the force amplified fastener assembly is fully nested within the cavity, locking tabs 1102a-1102c may spring radially inward so that clips, barbs, and/or other features of the locking tabs engage a corresponding feature (e.g., bottom edge, detent, slot, etc.) of a component (e.g., bottom structure 720) of the force amplified fastener assembly and removably hold the replaceable jacket thereto. According to some examples, the gap between the bottom edge circumference of replaceable jacket 1100 and the bottom edge circumference of a corresponding bottom structure (e.g., bottom structure 720) is sufficiently small so as to facilitate locking tabs 1102a-1102d engaging the bottom structure for retaining the replaceable jacket and bottom structure in the nested relationship. Additionally or alternatively such a relationship with respect portions of replaceable jacket 1100 and corresponding portions of components of a force amplified fastener assembly may be configured to prevent infiltration of debris and/or other matter into the area enclosed and/or protected by the replaceable jacket.

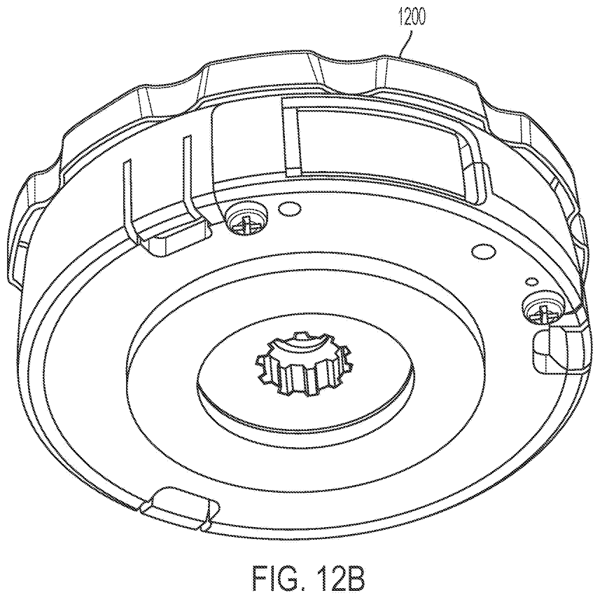

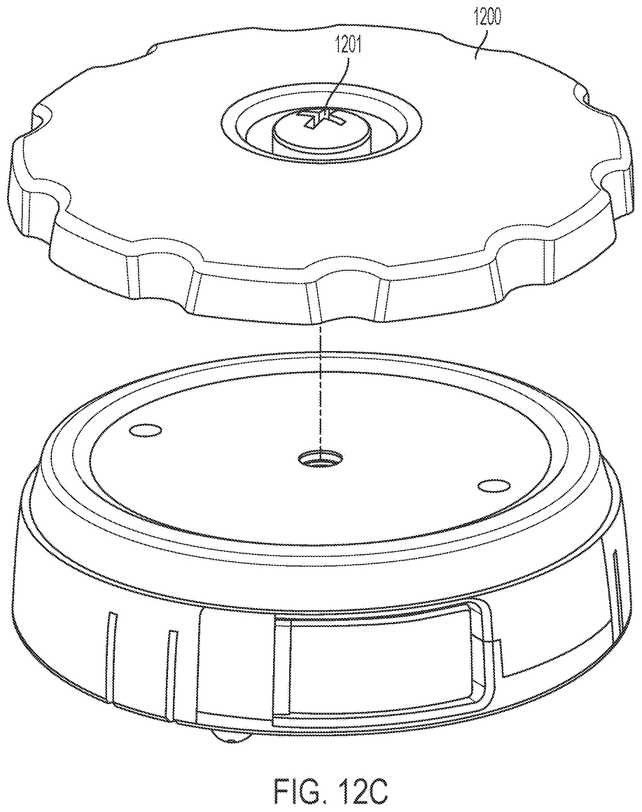

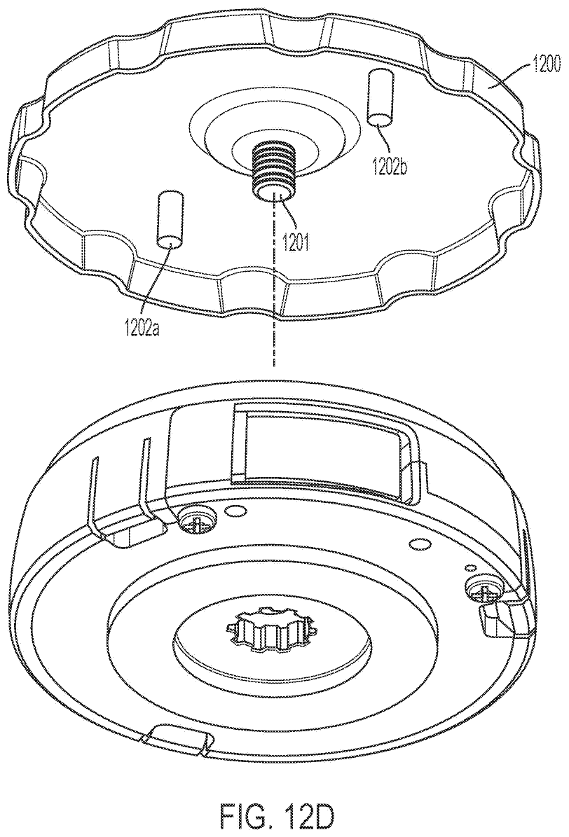

FIGS. 12A-12D illustrate another example of a removable/replaceable exterior surface covering presenting a protective surface for at least some portion of a force amplified fastener assembly. In particular, the removable/replaceable exterior surface covering of the example of FIGS. 12A-12D is provided in the form of a replaceable cap configured to cover a portion of force amplified fastener assembly 130 according to embodiments of the invention. The embodiment of replaceable cap 1200 in the illustrated example is provided in a configuration to cover at least a portion of the top surfaces of force amplified fastener assembly 130. Further, replaceable cap 1200 of the illustrated embodiment provides may comprise one or more features (e.g., rib structure, surface perturbations, rubberized over-molding, grasping member, etc.) for facilitating gripping and application of force. The illustrated embodiment of replaceable cap 1200, for example, includes rib structures disposed about the circumference of the replaceable cap, such as may be utilized to enable and/or enhance a user's grip upon force amplified fastener assembly 130.

Replaceable cap 1200 may present one or more protective surfaces (e.g., abrasion restive surface, wear surface, sacrificial surface, etc.) configured to provide protection to one or more surfaces and/or components of a force amplified fastener assembly. For example, replaceable cap 1200 of embodiments may be comprised of relatively hard materials, such as steel, titanium, and/or composites thereof to provide abrasion restive surfaces which are very slow to wear through and/or otherwise fail to protect surfaces and/or components thereunder in operation of the host power tool abrasive conditions. As another example, replaceable cap 1200 of embodiments may be comprised less hard materials, such as aluminum, zinc alloys, and/or composites thereof to provide wear surfaces which are somewhat slow to wear through and/or otherwise fail to protect surfaces and/or components thereunder in operation of the host power tool abrasive conditions. In yet another example, replaceable cap 1200 of embodiments may be comprised of somewhat softer materials, such as plastic, hard rubber, and/or composites thereof to provide sacrificial surfaces to take wear resulting from operation of the host power tool abrasive conditions. It should be appreciated that embodiments of replaceable cap 1200 may be comprised of more than one material and/or materials having different characteristics. For example, some embodiments of replaceable cap 1200 may comprise an under layer comprising a somewhat softer material (e.g., plastic or hard rubber) and an outer layer comprising a relatively hard material (e.g., steel or titanium). The under layer of such as configuration may facilitate lower material costs, deformation for installing and removing the removable cap, etc. while the outer layer provides protection to both the under layer and one or more components of the force amplified fastener assembly. Irrespective of the particular material or materials from replaceable cap 1200 is made, the removable cap of embodiments provides a replaceable covering to provide protection with respect to one or more aspects of a force amplified fastener assembly.

A surface of replaceable cap 1200 covering at least some portion of force amplified fastener assembly 130 may stand proud of, or otherwise provide covering to, one or more surfaces and/or components of the force amplified fastener assembly and accept impacts and abrasions during operation of a host power tool to protect and discourage damage to the surfaces, components, and/or other portions of the force amplified fastener assembly. For example, the surface of replaceable cap 1200 covering the top housing of the force amplified fastener assembly may provide protection to the top housing, or some portion thereof, and/or components thereon. Further, the surface of replaceable cap 1200 covering the top housing of the force amplified fastener assembly extends radially beyond (e.g., proud of) the side or circumferential surface of the force amplified fastener, and thus may provide protection to one or more components thereon (e.g., a button of a locking member, etc.). Additionally or alternatively, a surface of replaceable cap 1200 covering at least some portion of force amplified fastener assembly 130 may cover and protect and/or enclose one or more areas (e.g., interfaces between components of the force amplified fastener assembly) of a force amplified fastener assembly to thereby discourage infiltration by foreign material. For example, the surface of replaceable cap 1200 covering the top housing of force amplified fastener assembly 130 may provide protection to an interface between the top housing and bottom structure (e.g., the interface between top housing 710 and bottom structure 720 of the embodiment of FIGS. 7A-7F) and discourage ingress of material into an interior cavity of the force amplified fastener assembly.

Replaceable cap 1200 of embodiments presents a removable/replaceable exterior surface covering some portion of the remainder of a force amplified fastener assembly for providing protection thereto. Accordingly, replaceable caps of embodiments of the invention may comprise one or more features configured for facilitating their being removably retained in association with components of a force amplified fastener assembly. For example, a replaceable cap of embodiments of the invention may comprise various forms of attachment members (e.g., tabs, clips, hasps, clasps, etc.) configured to engage a portion of one or more components of a force amplified fastener assembly for releasable attachment thereto. Additionally or alternatively, replaceable caps may comprise various attachment points (e.g., vias, channels, slots, pads, etc.) for accepting one or more fasteners (e.g., screws, bolts, brads, rivets, adhesive, etc.) and/or attachment members (e.g., tabs, clips, hasps, clasps, etc.). For example, the embodiment of replaceable cap 1200 shown in FIGS. 12A-12D includes fastener 1201 (e.g., a machine screw) disposed through a via in a top housing thereof for threadedly engaging a top housing of a force amplified fastener assembly. The embodiment of replaceable cap 1200 shown in FIGS. 12A-12D further includes torque members 1202a and 1202b (FIG. 12D) disposed to engage corresponding features (e.g., the receivers shown in the top housing of the top housing in FIG. 12C) of a component of a force amplified fastener assembly to facilitate the transfer of tightening or loosening torque from the replaceable cap to other components of the force amplified fastener assembly.

Removable/replaceable exterior surface coverings of embodiments of the invention may be utilized alone or in combination. For example, some embodiments of the invention may provide a replaceable jacket (e.g., replaceable jacket 1100) in combination with a replaceable cap (e.g., replaceable cap 1200) for protecting components of a force amplified fastener assembly in forms that are readily replaceable by the user.

Force amplified fastener assemblies of embodiments of the invention are configured to provide mechanical advantage with respect to rotating a fastening element, whereby a user may be enabled to manually apply tightening or loosening torque by hand for tool-free changing of a detachable implement. Configurations of force amplified fastener assemblies herein may be utilized in place of a conventional lock nut for affixing detachable implements to power tools, even retrofitting a conventional lock nut in some cases. Accordingly, backwardly compatible detachable implement configurations may be accommodated with a force amplified fastener assembly of embodiments of the invention.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A force amplified fastener assembly for removably coupling a detachable implement to a power tool, the force amplified fastener assembly comprising:
a top housing;
a bottom structure, wherein the top housing and bottom structure are configured to nest and provide an enclosed area for housing one or more components of the force amplified fastener assembly;
a fastening element disposed between the top housing and the bottom structure and at least partially within the enclosed area, wherein the fastening element is configured for engagement with a shaft of the power tool;
a force amplifying gear train comprising a plurality of gears and at least one gear plate disposed in the enclosed area and in mechanical communication with the top housing, the bottom structure, and the fastening element, wherein the force amplifying gear train provides a mechanical advantage with respect to application of torque to the fastening element in response to torque applied to the top housing; and
a lock mechanism disposed at least partially within the enclosed area and operative to discourage rotation of the fastening element relative to the shaft in at least one rotational direction.

2. The force amplified fastener assembly of claim 1, wherein the lock mechanism comprises:
a first lock element configured to prevent relative movement of the top housing with respect to the gear plate in a first direction while allowing relative movement in a second direction when the lock mechanism is in a locked configuration.

3. The force amplified fastener assembly of claim 2, wherein the first lock element is configured to prevent relative movement of the top housing with respect to the gear plate in the second direction while allowing relative movement in the first direction when the lock mechanism is in an unlocked configuration.

4. The force amplified fastener assembly of claim 2, wherein the first lock element comprises a lock pawl, and wherein the lock mechanism further comprises:
a second lock element disposed in a pivotal relationship with bottom structure, wherein the second lock element is configured to allow the lock pawl to enter a lock position of the lock mechanism locked configuration when a portion of the second lock element is in a radially outward position and to encourage the lock pawl to enter an unlocked position of a lock mechanism unlocked configuration when the portion of the second lock element is in a radially inward position.

5. The force amplified fastener assembly of claim 2, wherein the first lock element comprises a lock pawl, and wherein the lock mechanism further comprises:
a second lock element disposed in a linear traversal relationship with the bottom structure, wherein the second lock element is configured to allow the lock pawl to enter a lock position of the lock mechanism locked configuration when a portion of the second lock element is in an un-depressed position and to encourage the lock pawl to enter an unlocked position of a lock mechanism unlocked configuration when the portion of the second lock element is in a depressed position.

6. The fore amplified fastener assembly of claim 5, wherein the first lock element encourages the lock pawl to enter the unlocked position via a third lock element.

7. The force amplified fastener assembly of claim 1, further comprising:
a grasping member assembly disposed upon a top surface of the top housing, wherein the grasping member assembly is configured to facilitate manual application of torque to the top housing by a user.

8. The force amplified fastener assembly of claim 7, wherein the grasping member assembly comprises:
a plate affixed to the top housing; and
a handle hingedly disposed with respect to plate, wherein the handle is configured to be disposed in a use position and a storage position.

9. The force amplified fastener assembly of claim 8, wherein the plate comprises:
spring plate configured to encourage the handle to remain in the use position when the handle is positioned in the use position and to encourage the handle to remain in the storage position when the handle is positioned in the storage position.

10. The force amplified fastener assembly of claim 1, further comprising:
a removable and replaceable exterior surface covering configured to provide a protective surface for at least a portion of the force amplified fastener assembly.

11. The force amplified fastener assembly of claim 10, wherein the removable and replaceable exterior surface covering comprises:
a replaceable jacket covering at least a portion of the top housing and at least a portion of the bottom structure, wherein the replaceable jacket provides a protective surface for the at least a portion of the top housing and at least a portion of the bottom structure, and wherein the replaceable jacket is configured to provide protection to at least a portion of the lock mechanism.

12. The force amplified fastener assembly of claim 10, wherein the removable and replaceable exterior surface covering comprises:
a replaceable cap covering at least a portion of the top housing, wherein the replaceable cap provides a protective surface for the at least a portion of the top housing, and wherein the replaceable cap is configured to provide protection to at least a portion of the lock mechanism.

13. A method for removably coupling a detachable implement to a power tool, the method comprising:
interfacing a force amplified fastener assembly with a shaft of the power tool, wherein the force amplified fastener assembly includes a top housing, a bottom structure, a fastening element, a force amplifying gear train, and a lock mechanism, wherein the top housing and bottom structure are configured to nest and provide an enclosed area for housing one or more components of the force amplified fastener assembly, wherein the fastening element is disposed between the top housing and the bottom structure and at least partially within the enclosed area, wherein the fastening element is configured for engagement with a shaft of the power tool, wherein the force amplifying gear train comprises a plurality of gears and at least one gear plate disposed in the enclosed area and in mechanical communication with the top housing, the bottom structure, and the fastening element, wherein the force amplifying gear train provides a mechanical advantage with respect to application of torque to the fastening element in response to torque applied to the top housing, and wherein the lock mechanism is disposed at least partially within the enclosed area and is operative to discourage rotation of the top housing relative to the gear plate in at least a loosening direction;
engaging a first lock element of the lock mechanism and causing a second lock element of the lock mechanism to enter an unlocked position configured to allow rotation of the top housing relative to the gear plate in the loosening direction; and
applying torque in the loosening direction to the top housing and inducing torque at the fastening element in the loosening direction, wherein the rotation of the top housing relative to the gear plate causes the force amplifying gear train to provide a mechanical advantage with respect to the torque induced at the fastening element.

14. The method of claim 13, wherein the second lock element is configured to prevent relative movement of the top housing with respect to the gear plate in the loosening direction while allowing relative movement in a tightening direction when the lock mechanism is in a locked configuration.

15. The method of claim 14, wherein the second lock element is configured to prevent relative movement of the top housing with respect to the gear plate in the tightening direction while allowing relative movement in the loosening direction when the lock mechanism is in an unlocked configuration.

16. The method of claim 14, wherein the second lock element comprises a lock pawl, and wherein the first lock element is disposed in a pivotal relationship with bottom structure, the method further comprising:
releasing the first lock element to move in a radially outward position and causing the second lock element to enter a locked position configured to discourage rotation of the top housing relative to the gear plate in the loosening direction.

17. The method of claim 14, wherein the second lock element comprises a lock pawl, and wherein the first lock element is disposed in a linear traversal relationship with the bottom structure, the method further comprising:
releasing the first lock element to move in an un-depressed position and causing the second lock element to enter a locked position.

18. The method of claim 13, further comprising:
moving a handle of a grasping member assembly disposed upon a top surface of the top housing between a storage position and a use position, wherein the grasping member assembly is configured to facilitate manual application of torque to the top housing by a user, and wherein the applying torque in the loosening direction to the top housing comprises:
applying torque in the loosening direction to the handle of the grasping member assembly disposed upon the top surface of the top housing.

19. The method of claim 18, wherein the grasping member assembly comprises a spring plate affixed to the top housing, and wherein the spring plate is configured to encourage the handle to remain in the use position when the handle is positioned in the use position and to encourage the handle to remain in the storage position when the handle is positioned in the storage position.

20. The method of claim 13, further comprising:
covering at least a portion of the force amplified fastener assembly with a removable and replaceable exterior surface covering configured to provide a protective surface for the at least a portion of the force amplified fastener assembly.

21. The method of claim 20, wherein the removable and replaceable exterior surface covering comprises a replaceable jacket covering at least a portion of the top housing and at least a portion of the bottom structure, wherein the replaceable jacket provides a protective surface for the at least a portion of the top housing and at least a portion of the bottom structure, and wherein the replaceable jacket is configured to provide protection to at least a portion of the lock mechanism.

22. The method of claim 20, wherein the removable and replaceable exterior surface covering comprises a replaceable cap covering at least a portion of the top housing, wherein the replaceable cap provides a protective surface for the at least a portion of the top housing, and wherein the replaceable cap is configured to provide protection to at least a portion of the lock mechanism.

23. A system for removably coupling a detachable implement to a power tool, the system comprising:
force amplified fastener assembly including a top housing, a bottom structure, a fastening element, a force amplifying gear train, and a lock mechanism, wherein the top housing and bottom structure are configured to nest and provide an enclosed area for housing one or more components of the force amplified fastener assembly, wherein the fastening element is disposed between the top housing and the bottom structure and at least partially within the enclosed area, wherein the fastening element is configured for engagement with a shaft of the power tool, wherein the force amplifying gear train comprises a plurality of gears and at least one gear plate disposed in the enclosed area and in mechanical communication with the top housing, the bottom structure, and the fastening element, wherein the force amplifying gear train provides a mechanical advantage with respect to application of torque to the fastening element in response to torque applied to the top housing, and wherein the lock mechanism is disposed at least partially within the enclosed area and is operative to discourage rotation of the top housing relative to the gear plate in at least a loosening direction; and
an exterior surface covering configured to provide a removable and replaceable protective surface for at least a portion of the force amplified fastener assembly.

24. The system of claim 23, wherein the exterior surface covering comprises:
a replaceable jacket covering at least a portion of the top housing and at least a portion of the bottom structure, wherein the replaceable jacket provides a protective surface for the at least a portion of the top housing and at least a portion of the bottom structure, and wherein the replaceable jacket is configured to provide protection to at least a portion of the lock mechanism.

25. The system of claim 23, wherein the exterior surface covering comprises:
a replaceable cap covering at least a portion of the top housing, wherein the replaceable cap provides a protective surface for the at least a portion of the top housing, and wherein the replaceable cap is configured to provide protection to at least a portion of the lock mechanism.
